(19) United States
(12) Patent Application Publication
(10) Pub. No.: US 2025/0124626 A1
(43) Pub. Date: Apr. 17, 2025

(54) GENERATIVE EXPAND IN IMAGE EDITING APPLICATIONS

(71) Applicant: ADOBE INC., SAN JOSE, CA (US)

(72) Inventors: Dana Michelle Jefferson, Astoria, NY (US); Michael Spencer Cragg, Troy, MI (US); Davis Taylor Brown, Seattle, WA (US)

(21) Appl. No.: 18/915,622

(22) Filed: Oct. 15, 2024

Related U.S. Application Data
(60) Provisional application No. 63/590,595, filed on Oct. 16, 2023.

(51) Int. Cl. G06T 11/60; G06F 3/04845; G06T 3/60

(52) U.S. Cl. CPC G06T 11/60; G06F 3/04845; G06T 3/60; G06T 2200/24

(57) ABSTRACT

A method, apparatus, non-transitory computer readable medium, and system for image generation include obtaining, via a user interface, an input image and a user input that indicates a frame for modifying the input image including a first region inside of the input image and a second region outside of the input image, and excluding a third region inside of the input image. A modified image is generated using an image generation model. The modified image includes original content from the input image in the first region and generated content in the second region, and excluding content from the input image in the third region. The modified image is presented for display in the user interface.

### CROSS-REFERENCE TO RELATED APPLICATION

This application claims benefit under 35 U.S.C. § 119 to U.S. Provisional Application No. 63/590,595, filed on Oct. 16, 2023, in the United States Patent and Trademark Office, the disclosure of which is incorporated by reference herein in its entirety.

### BACKGROUND

The following relates generally to image processing, and more specifically to image generation using machine learning. Image processing refers to the use of a computer to edit a digital image using an algorithm or a processing network. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, includes the use of machine learning models to synthesize images. Machine learning models can be used for various image generation tasks including image super-resolution, generation of images with perceptual metrics, conditional generation (e.g., generation based on text guidance), image inpainting, and image manipulation. For example, diffusion models are trained to take random noise as input and generate unseen images with features similar to the training data.

### SUMMARY

The present disclosure describes systems and methods for image processing. Embodiments of the present disclosure comprise an image processing apparatus configured to generate a modified image based on an input image. In some examples, a user interface obtains a user input that indicates a frame for modifying the input image including a first region inside of the input image and a second region outside of the input image. The image processing apparatus generates a layered image including the modified image and the input image. An image generation model expands image boundaries of the input image to obtain a modified image. The modified image includes original content from the input image in the first region and generated content in the second region.

A method, apparatus, and non-transitory computer readable medium for image processing are described. One or more embodiments of the method, apparatus, and non-transitory computer readable medium include obtaining, via a user interface an input image and a user input that indicates a frame for modifying the input image, wherein the frame includes a first region inside of the input image and a second region outside of the input image, and excludes a third region inside of the input image; generating, using an image generation model, a modified image including original content from the input image in the first region and generated content in the second region, and excluding content from the input image in the third region; and presenting the modified image for display in the user interface.

A method, apparatus, and non-transitory computer readable medium for image processing are described. One or more embodiments of the method, apparatus, and non-transitory computer readable medium include obtaining an input image and a frame including at least a portion of the input image, wherein the input image is arranged at an oblique angle with respect to the frame; generating, using an image generation model, a modified image including original content from the input image and generated content within a portion of the frame outside the input image; and presenting the modified image for display in the user interface.

An apparatus and method for image processing are described. One or more embodiments of the apparatus and method include a memory component; a processing device coupled to the memory component, the processing device configured to perform operations comprising: obtaining, via a user interface, a user input that indicates a frame including a first region inside of an input image and a second region outside of the input image, and excluding a third region inside of the input image; and generating, using an image generation model, a modified image including original content from the input image in the first region and generated content in the second region, and excluding content from the input image in the third region.

### BRIEF DESCRIPTION OF THE DRAWINGS

FIG. 1 shows an example of an image processing system according to aspects of the present disclosure.

FIG. 2 shows an example of a method for conditional media generation according to aspects of the present disclosure.

FIG. 3 shows an example of a user interface according to aspects of the present disclosure.

FIG. 4 shows an example of generative expansion according to aspects of the present disclosure.

FIG. 5 shows an example of generative expansion and cropping according to aspects of the present disclosure.

FIG. 6 shows an example of image expansion according to aspects of the present disclosure.

FIG. 7 shows an example of generative expansion according to aspects of the present disclosure.

FIG. 8 shows an example of expansion without a prompt according to aspects of the present disclosure.

FIG. 9 shows an example of expansion with a prompt according to aspects of the present disclosure.

FIGS. 10 through 12 show examples of expansion and rotation according to aspects of the present disclosure.

FIGS. 13 through 15 show examples of a sequence of image editing operations according to aspects of the present disclosure.

FIG. 16 shows an example of a method for image processing according to aspects of the present disclosure.

FIG. 17 shows an example of an image processing apparatus according to aspects of the present disclosure.

FIGS. 18 through 20 show examples of a context bar according to aspects of the present disclosure.

FIG. 21 shows an example of a guided diffusion model according to aspects of the present disclosure.

FIG. 22 shows an example of a U-Net architecture according to aspects of the present disclosure.

FIG. 23 shows an example of a method for image processing according to aspects of the present disclosure.

FIG. 24 shows an example of a diffusion process according to aspects of the present disclosure.

FIG. 25 shows an example of a computing device for image processing according to aspects of the present disclosure.

### DETAILED DESCRIPTION

The present disclosure describes systems and methods for image processing. Embodiments of the present disclosure comprise an image processing apparatus configured to generate a modified image based on an input image. In some examples, a user interface obtains a user input that indicates a frame including a first region inside of the input image and a second region outside of the input image. The image processing apparatus generates a layered image including the modified image and the input image. An image generation model expands image boundaries of the input image to obtain a modified image. The modified image includes original content from the input image in the first region and generated content in the second region.

Users capture many photos on digital cameras nowadays. Some photos need additional editing using an image editing application, for example, adjusting the aspect ratio, transforming a photo to tell a larger story, or accounting for off-centered or cut-off images. In some cases, there are also missing areas or missing pixels in photos and there is a need to patch these areas that are consistent with other parts of the photos.

Conventional generative AI models such as Dall-E and Stable Diffusion depend on a prompt manually input by a user. In some cases, it is difficult for users to come up with a text prompt that can describe the desired output. Additionally, these models require users to perform tiling operations to expand a canvas on more than one side.

Embodiments of the present disclosure include an image processing apparatus configured to expand multiple sides of an input image simultaneously to obtain a modified image. A user interface receives a user input that indicates a frame including a first region inside of the input image and a second region outside of the input image. Then an image generation model (e.g., a diffusion model) generates a modified image including original content from the input image in the first region and generated content in the second region.

In some examples, the user interface enables users to expand the canvas and resize an input image as part of the crop workflow (i.e., an image uploaded to an image editing application for cropping). Accordingly, users save time on tedious tasks by reducing the number of steps needed to achieve desired outcome. The user interface displays multiple variations of modified images for users to choose from.

In an embodiment, the image processing model based on the present disclosure is not dependent on text prompts for image expansion. That is, prompts are optional. If users do not provide a text prompt, the image processing model fills the target regions (e.g., additional areas following an outcropping selection) based on the surroundings. In some cases, with the assistance of text prompts, the image processing model expands and generates content that is unique and likely not a part of the original input image (e.g., a text prompt specifying “cute bamboo wooden surf shack”).

Therefore, users can simultaneously crop (e.g., crop in or shrink), expand the image boundaries of an input image, and/or rotate the input image all in one action. With the inclusion of a text prompt (available in over 100 languages), the image processing model expands the input image to include unique components. Without a text prompt, generated content from the image processing model seamlessly blends with the existing image and expands the canvas. Patterns may be expanded upon as well and lead to more seamless results. In some examples, the user interface receives a pattern expansion selection indicating a pattern expansion option from a set of pattern expansion options including a generative expansion option and an algorithmic expansion option.

In some embodiments, the user interface implements a context bar. On the context bar, users can choose from “Fill” dropdown menu which generative expand mode they want to crop with. For example, background expand mode (default) leads to filling the expanded area with background color or transparent pixels. Generative expand mode leads to generating high-quality new content to fill expanded regions with or without a text prompt. Content-aware fill mode leads to sampling content from part of the input image and using it to fill a small area.

Embodiments of the present disclosure provide systems and methods that improve on conventional image processing tools by increasing the efficiency of image editing tasks such as image generation, image outpainting, image rotation, etc. Users can operate on the user interface to automatically perform complex editing techniques including simultaneous rotation and generative expansion. For example, expanded content can be generated for corner areas that result from rotation of an original image within a frame. By incorporating generative expand via a cropping tool in image editing applications, users can more efficiently expand the image boundaries through the crop tool with the crop handles. Users, via the user interface and the backend image generation model, avoid time-consuming steps (e.g., outcrop using a crop tool, switch to a selection tool, select the outcropped area, enter a text prompt, generate). Users can simultaneously crop, expand the image boundaries of an input image, and/or rotate the input image all in one action. The canvas is expanded to include generated content that seamlessly blends with the input image.

Accordingly, embodiments of the disclosure simplify and speed up image expansion and editing process compared to conventional models, both for outpainting and modifying an existing image. Additionally, the user interface enables improved visualization by presenting a layered image that includes the modified image (e.g., outpainted image) and the background image at different layers. The layered image is located at a specified region of the user interface. In some examples, the layered image includes metadata specifying inputs of the image generation model for generating the modified image. Hence, embodiments increase efficiency and controllability of the generative process and editing process while ensuring that generated content (after performing generative expansion) is similar in terms of composition, shape, perspective, and orientation, compared to original content of the input image.

### Image Processing and Editing

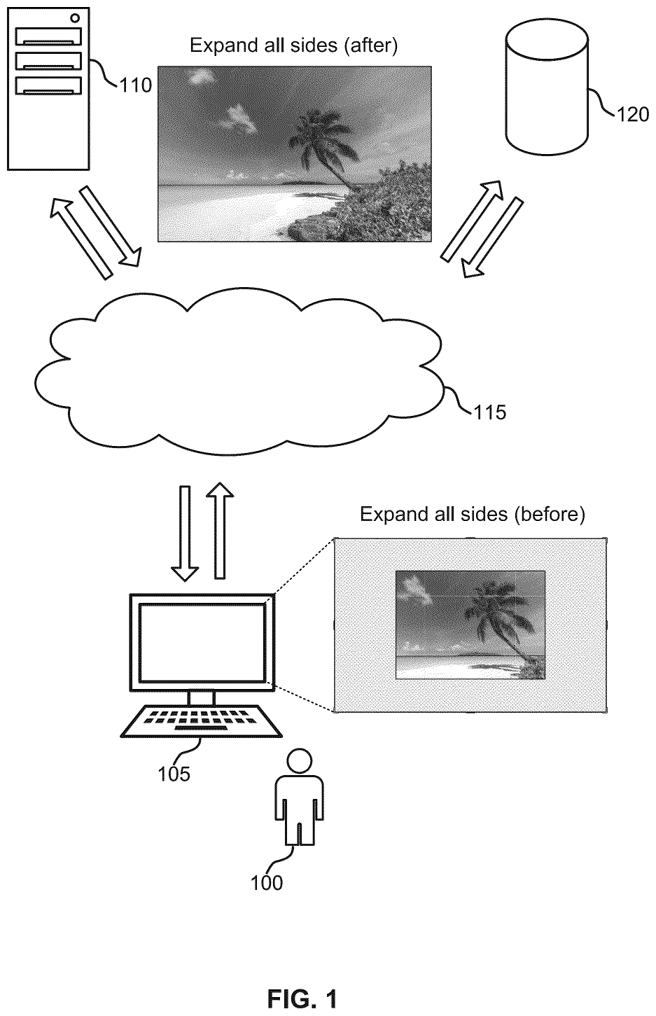

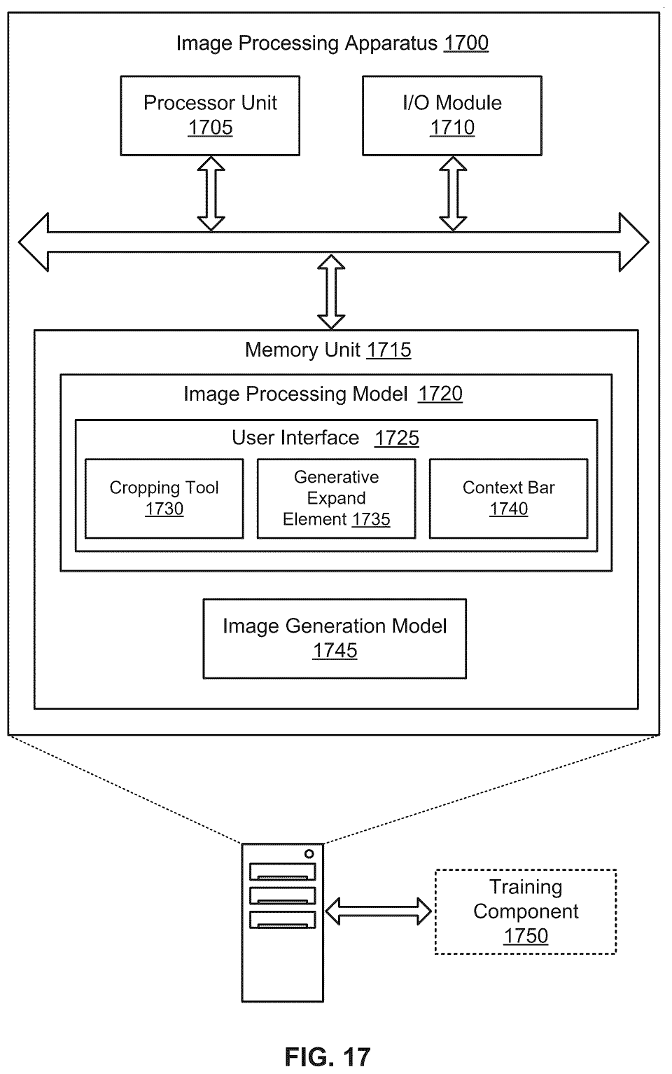

FIG. 1 shows an example of an image processing system according to aspects of the present disclosure. The example shown includes user 100, user device 105, image processing apparatus 110, cloud 115, and database 120. Image processing apparatus 110 is an example of, or includes aspects of, the corresponding element described with reference to FIG. 17.

In an example shown in FIG. 1, user 100 provides an input image via a user interface and user 100 wants to expand all sides of the input image. A user input from user 100 indicates, via the user interface, a frame including a first region inside of the input image and a second region outside of the input image. Additionally or alternatively, the user input indicates the frame excluding a third region inside of the input image. The input image and the frame (e.g., a cropping selection or a drag input via a cropping tool in the user interface) are transmitted to image processing apparatus 110, e.g., via user device 105 and cloud 115. Image processing apparatus 110 generates, using an image generation model, a modified image including original content from the input image in the first region and generated content in the second region. In some cases, the modified image excludes content from the input image in the third region. Image processing apparatus 110 returns the modified image to user 100 via cloud 115 and user device 105. The modified image is presented for display in the user interface.

User device 105 may be a personal computer, laptop computer, mainframe computer, palmtop computer, personal assistant, mobile device, or any other suitable processing apparatus. In some examples, user device 105 includes software that incorporates an image processing application (e.g., an image editing tool). In some examples, the image processing application on user device 105 may include functions of image processing apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

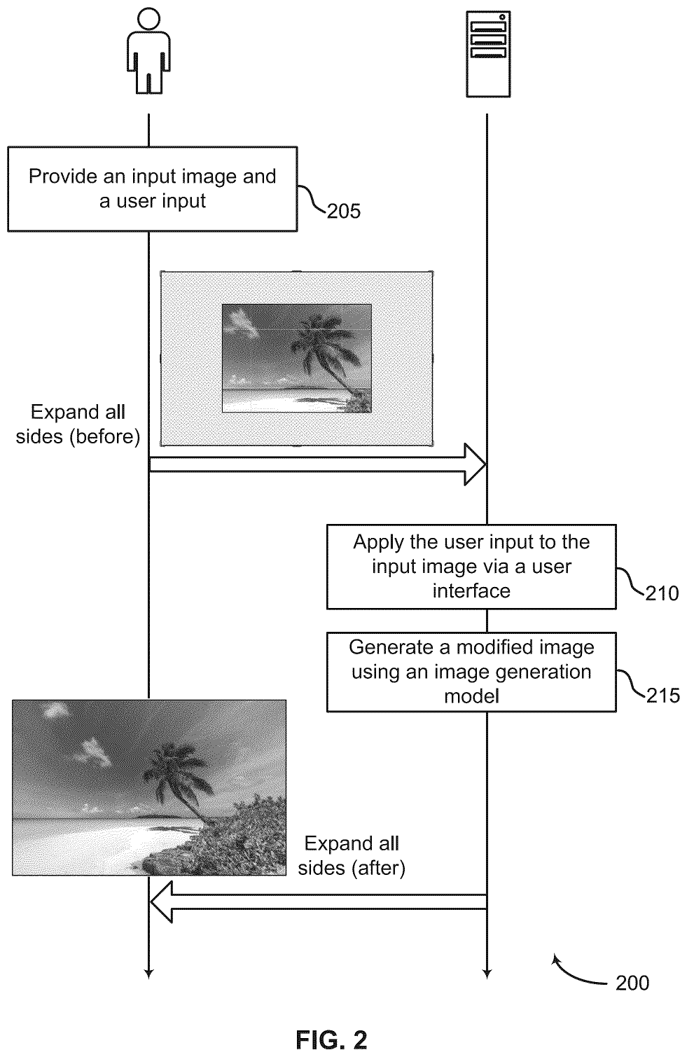

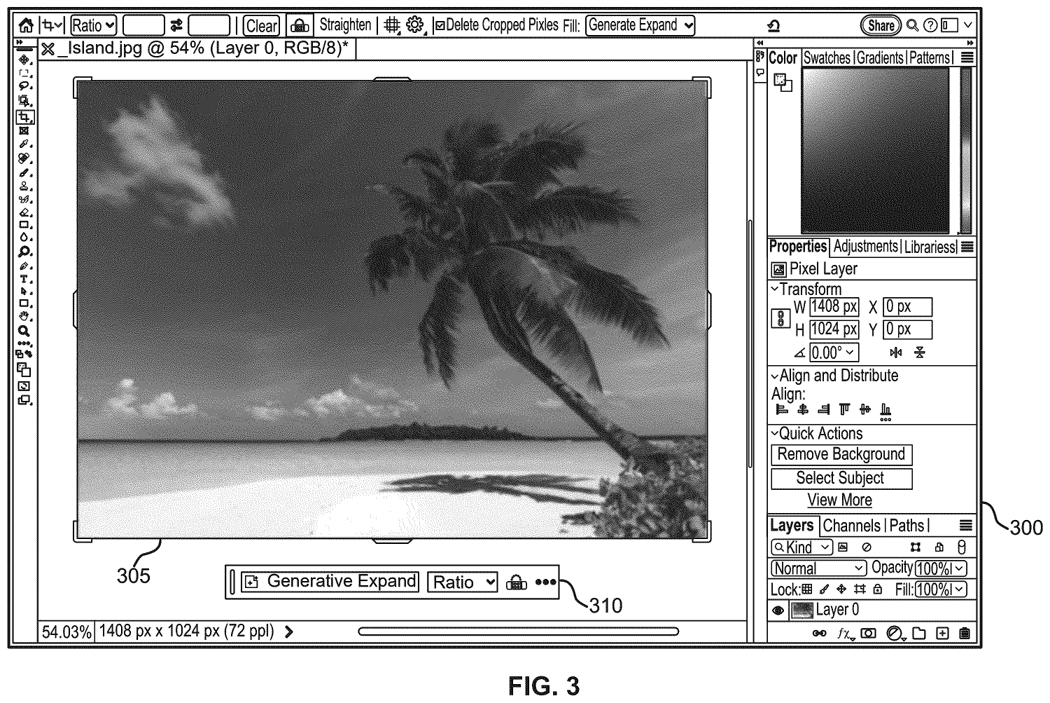

Image processing apparatus 110 includes a computer-implemented network comprising a user interface and an image generation model. Image processing apparatus 110 may also include a processor unit, a memory unit, and an I/O module. A training component may be implemented on an apparatus other than image processing apparatus 110. The training component is used to train an image generation model. Additionally, image processing apparatus 110 can communicate with database 120 via cloud 115. In some cases, the architecture of the image generation network is also referred to as a network, a machine learning model, or a network model. Further detail regarding the architecture of image processing apparatus 110 is provided with reference to FIGS. 17-22. Further detail regarding the user interface for image processing is provided with reference to FIGS. 3-15. Further detail regarding the operation of image processing apparatus 110 is provided with reference to FIGS. 2, 16 and 23.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training an image generation model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

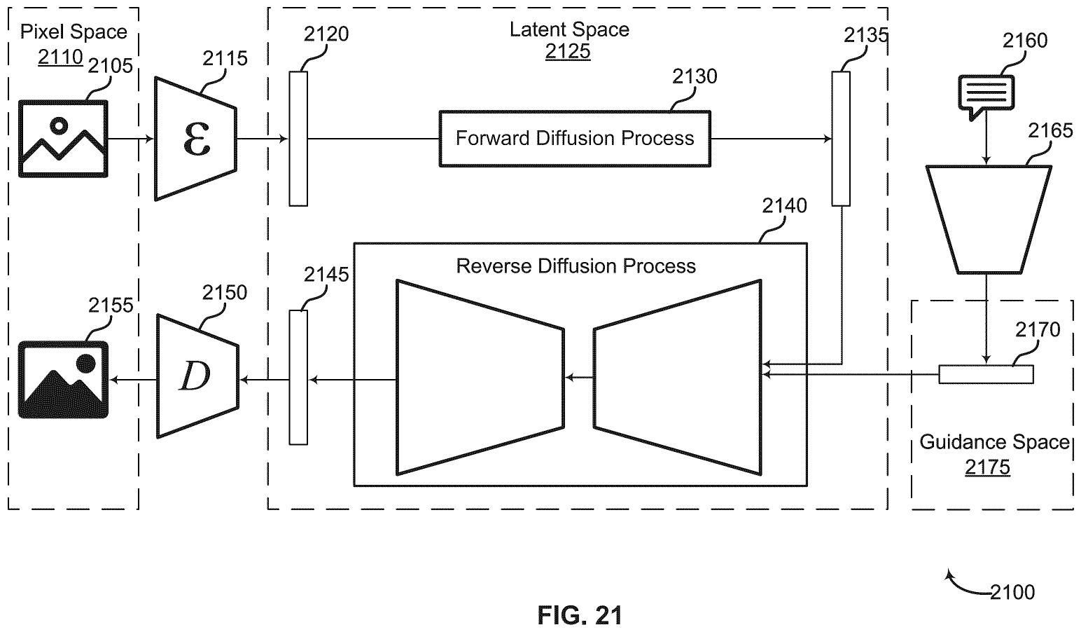

FIG. 2 shows an example of a method 200 for conditional media generation according to aspects of the present disclosure. In some examples, method 200 describes an operation of the image processing model 1720 described with reference to FIG. 17 such as an application of the guided latent diffusion model 2100 described with reference to FIG. 21. In some examples, these operations are performed by a system including a processor executing a set of codes to control functional elements of an apparatus such as the image processing apparatus described in FIGS. 1 and 17.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides an input image and a user input. In some examples, the user input includes a crop selection using a cropping tool. The user, via the cropping tool, indicates a frame which includes a first region inside the input image (or equivalent to the input image since the user wants to expand all sides) and a second region outside the input image (e.g., an outpainting area). In an example shown in FIG. 2, the input image includes a tropical landscape comprising a tree, bushes, sea, sand, beach, and sky. The user-specified frame is larger than the input image and contains the first region inside the input image and the second region outside the input image. In some cases, the operations of this step refer to, or may be performed by, a user as described with reference to FIG. 1.

At operation 210, the system applies the user input to the input image via a user interface. In some cases, the operations of this step refer to, or may be performed by, an image processing apparatus as described with reference to FIGS. 1 and 17.

At operation 215, the system generates a modified image using an image generation model. The modified image includes the first region (i.e., the input image) and the second region outside the input image, where the second region is generated by the image generation model. The style of the second region is consistent with the style of the input image (i.e., the first region in this case). In some cases, the operations of this step refer to, or may be performed by, an image processing apparatus as described with reference to FIGS. 1 and 17.

FIG. 3 shows an example of a user interface 300 according to aspects of the present disclosure. The example shown includes user interface 300, input image 305, and context bar 310.

According to some embodiments, user interface 300 obtains an input image 305 (e.g., located in the middle of user interface 300). For example, the input image 305 includes a tropical landscape comprising a tree, bushes, sea, sand, beach, and sky. In some examples, user interface 300 obtains a user input that indicates a frame including a first region inside of the input image and a second region outside of the input image.

In some examples, user interface 300 rotates the input image, where the original content from the input image is rotated in the modified image. In some examples, user interface 300 identifies a target orientation based on content of the input image, where the input image is rotated based on the target orientation.

In some examples, user interface 300 receives a pattern expansion selection indicating a pattern expansion option from a set of pattern expansion options including a generative expansion option and an algorithmic expansion option. In some examples, user interface 300 displays a preview for each of the set of modified images, where the modified image is selected based on the preview.

In some examples, user interface 300 provides a generative expand element in a user interface 300. In some examples, user interface 300 receives a generative expand input via the generative expand element. In some examples, user interface 300 initiates a generative expand mode based on the generative expand input, where the modified image is generated based on the generative expand mode. In some examples, user interface 300 provides a context bar 310 in a user interface 300 at a location based on the input image 305. In some examples, user interface 300 receives a guidance input via the context bar 310, where the generated content is based on the guidance input. In some examples, the context bar 310 displays a token indicating a category of the guidance input. In some aspects, the user input includes a selection of a preset image aspect ratio. In some examples, user interface 300 receives a pattern expansion selection indicating a pattern expansion option from a set of pattern expansion options including a generative expansion option and an algorithmic expansion option.

In some examples, the user interface 300 includes a generative expand element configured to receive a generative expand input and initiate a generative expand mode based on the generative expand input, where the modified image is generated based on the generative expand mode. In some aspects, the user interface 300 includes a context bar 310 at a location based on the input image 305 and configured to receive a guidance input, where the generated content is based on the guidance input.

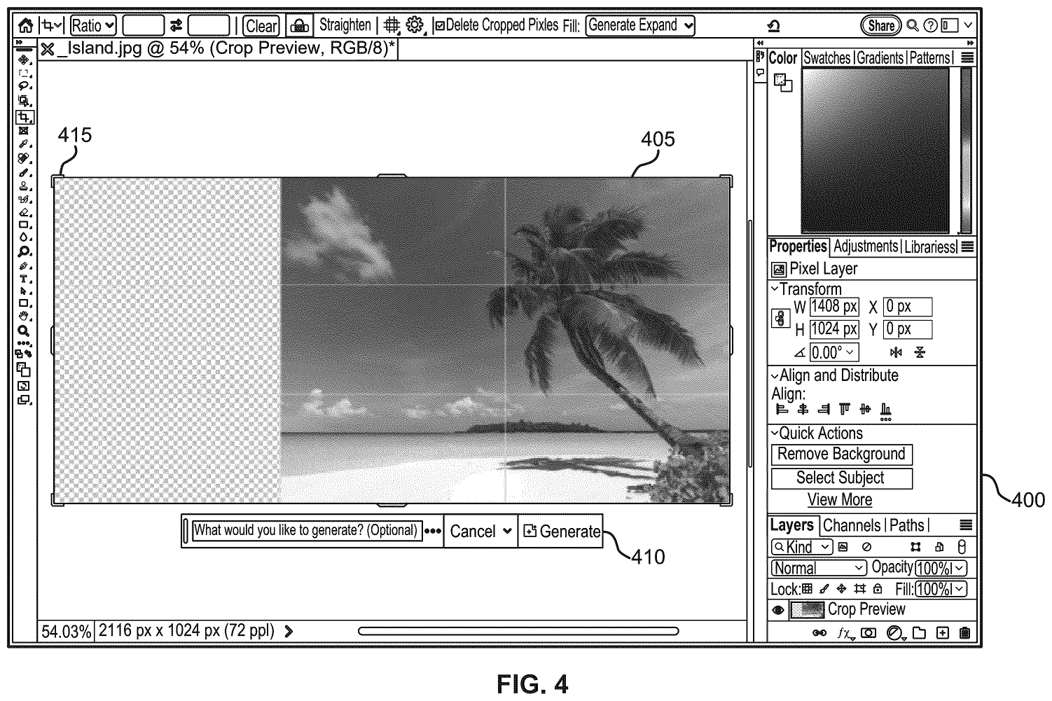

User interface 300 is an example of, or includes aspects of, the corresponding element described with reference to FIGS. 4-15, and 17. Input image 305 is an example of, or includes aspects of, the corresponding element described with reference to FIGS. 4-7, 10, and 13. Context bar 310 is an example of, or includes aspects of, the corresponding element described with reference to FIGS. 4-15, and 17-20.

FIG. 4 shows an example of generative expansion according to aspects of the present disclosure. The example shown includes user interface 400, input image 405, context bar 410, and cropping tool 415. User interface 400 is an example of, or includes aspects of, the corresponding element described with reference to FIGS. 3, 5-15, and 17.

In some examples, user interface 400 provides a cropping tool 415 to a user. In some examples, user interface 400 receives a drag input via the cropping tool 415, where the frame is based on the drag input. The user can specify a size of the frame by adjusting the drag input via the cropping tool 415. In an example shown in FIG. 3, the target frame encompasses the input image 405 and includes an additional region that is outside of the input image 405.

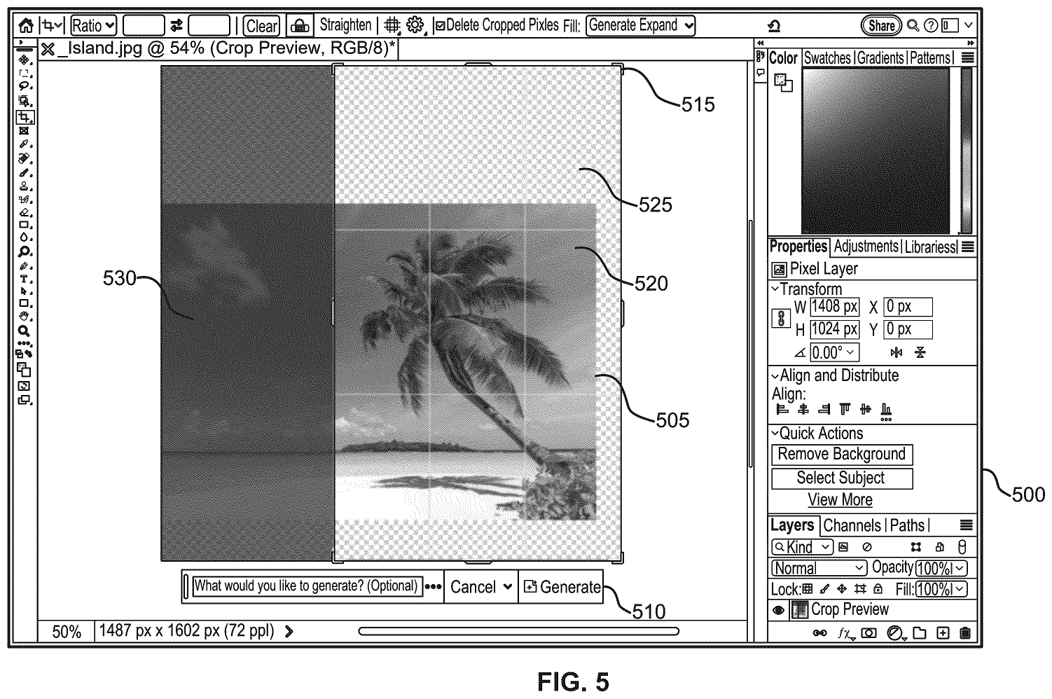

Input image 405 is an example of, or includes aspects of, the corresponding element described with reference to FIGS. 3, 5-7, 10, and 13. Context bar 410 is an example of, or includes aspects of, the corresponding element described with reference to FIGS. 3, 5-15, and 17-20. Cropping tool 415 is an example of, or includes aspects of, the corresponding element described with reference to FIGS. 5, 6, 11, 14, and 17.

FIG. 5 shows an example of generative expansion and cropping according to aspects of the present disclosure. The example shown includes user interface 500, input image 505, context bar 510, cropping tool 515, first region 520, second region 525, and third region 530. User interface 500 is an example of, or includes aspects of, the corresponding element described with reference to FIGS. 3, 4, 6-15, and 17.

In some examples, user interface 500 provides a cropping tool 515 to a user. In some examples, user interface 500 receives a drag input via the cropping tool 515, where the frame is based on the drag input. The user can specify a size of the frame by adjusting the drag input via the cropping tool 515. In an example shown in FIG. 5, the frame encompasses a first portion of the input image 505 and includes an additional region that is outside of the input image 505. The user is primarily interested in the tree and can adjust the drag input to focus on the first portion of the input image 505 that covers the tree. The frame does not include a second portion of the input image 505 (i.e., the portion towards the left and away from the tree).

According to some embodiments, user interface 500 obtains an input image 505 and a user input that indicates a frame including a first region 520 inside of the input image 505 and a second region 525 outside of the input image 505 and excluding a third region 530 inside of the input image 505.

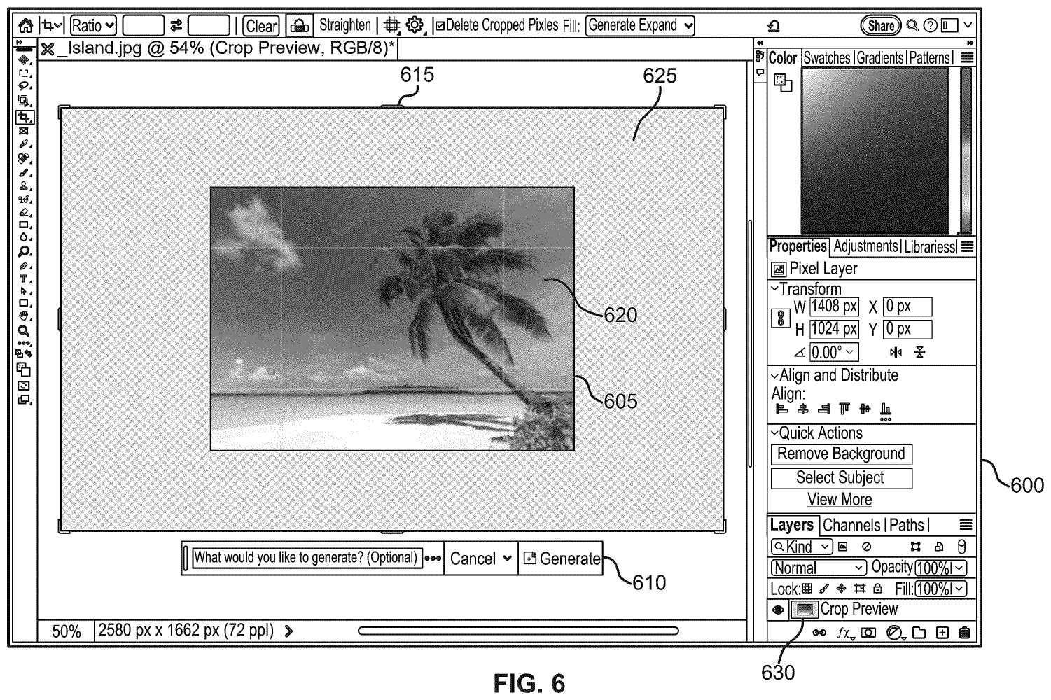

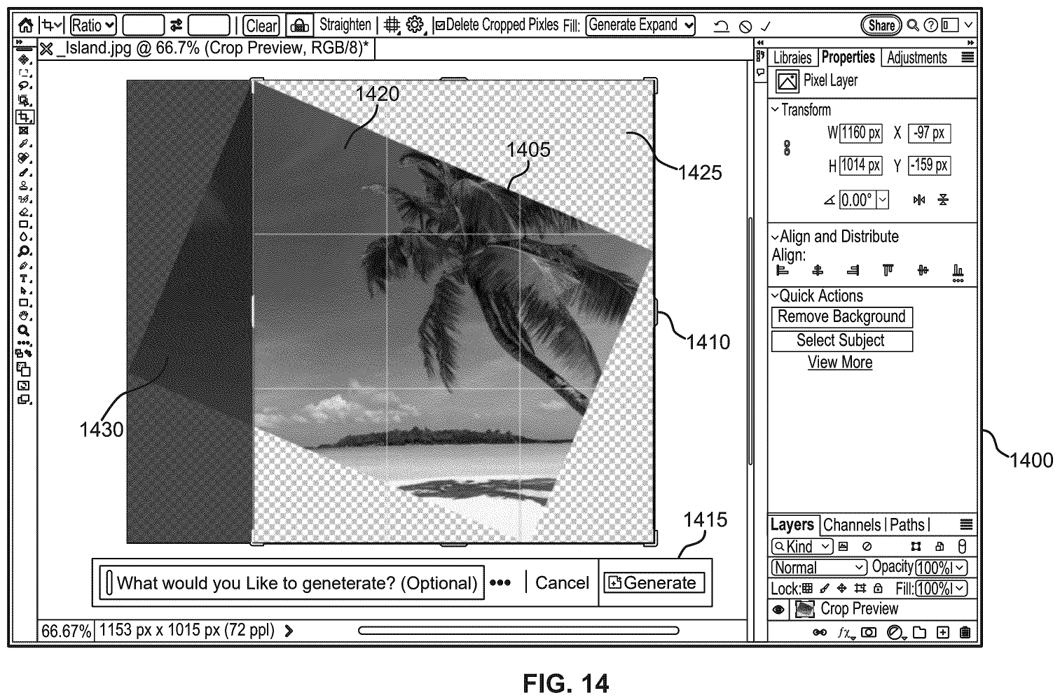

Input image 505 is an example of, or includes aspects of, the corresponding element described with reference to FIGS. 3, 4, 6, 7, 10, and 13. Context bar 510 is an example of, or includes aspects of, the corresponding element described with reference to FIGS. 3, 4, 6-15, and 17-20. Cropping tool 515 is an example of, or includes aspects of, the corresponding element described with reference to FIGS. 4, 6, 11, 14, and 17. First region 520 is an example of, or includes aspects of, the corresponding element described with reference to FIGS. 6 and 14. Second region 525 is an example of, or includes aspects of, the corresponding element described with reference to FIGS. 6, 11 and 14. Third region 530 is an example of, or includes aspects of, the corresponding element described with reference to FIG. 14.

FIG. 6 shows an example of image expansion according to aspects of the present disclosure. The example shown includes user interface 600, input image 605, context bar 610, cropping tool 615, first region 620, second region 625, and preview 630. User interface 600 is an example of, or includes aspects of, the corresponding element described with reference to FIGS. 3-5, 7-15, and 17.

In some examples, user interface 600 presents the modified image for display in the user interface 600. In some examples, user interface 600 provides a cropping tool 615 to a user. In some examples, user interface 600 receives a drag input via the cropping tool 615, where the frame is based on the drag input.

In some examples, user interface 600 provides a generative expand element (e.g., located at the bottom side of the user interface 600). In some examples, a content bar includes the generative expand element (e.g., “Generate”). In some examples, user interface 600 receives a generative expand input via the generative expand element (e.g., a user clicks on “Generate” field of the context bar 610). In some examples, user interface 600 displays a preview 630 (e.g., a crop preview) based on a frame dragged or selected by cropping tool 615.

According to some embodiments, user interface 600 receives a user input that indicates a frame including a first region 620 inside of an input image 605 and a second region 625 outside of the input image 605. In some examples, the user interface 600 includes a cropping tool 615 configured to receive a drag input, where the frame is based on the drag input.

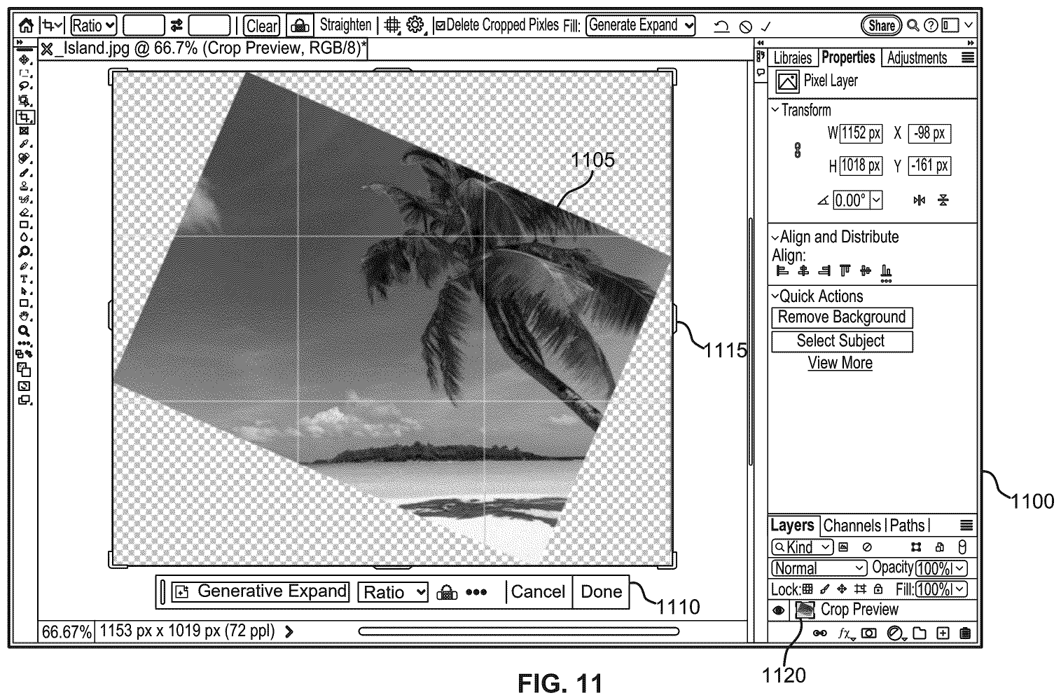

Input image 605 is an example of, or includes aspects of, the corresponding element described with reference to FIGS. 3-5, 7, 10, and 13. Context bar 610 is an example of, or includes aspects of, the corresponding element described with reference to FIGS. 3-5, 7-15, and 17-20. Cropping tool 615 is an example of, or includes aspects of, the corresponding element described with reference to FIGS. 4, 5, 11, 14, and 17. First region 620 is an example of, or includes aspects of, the corresponding element described with reference to FIGS. 5 and 14. Second region 625 is an example of, or includes aspects of, the corresponding element described with reference to FIGS. 5 and 14. Preview 630 is an example of, or includes aspects of, the corresponding element described with reference to FIG. 11.

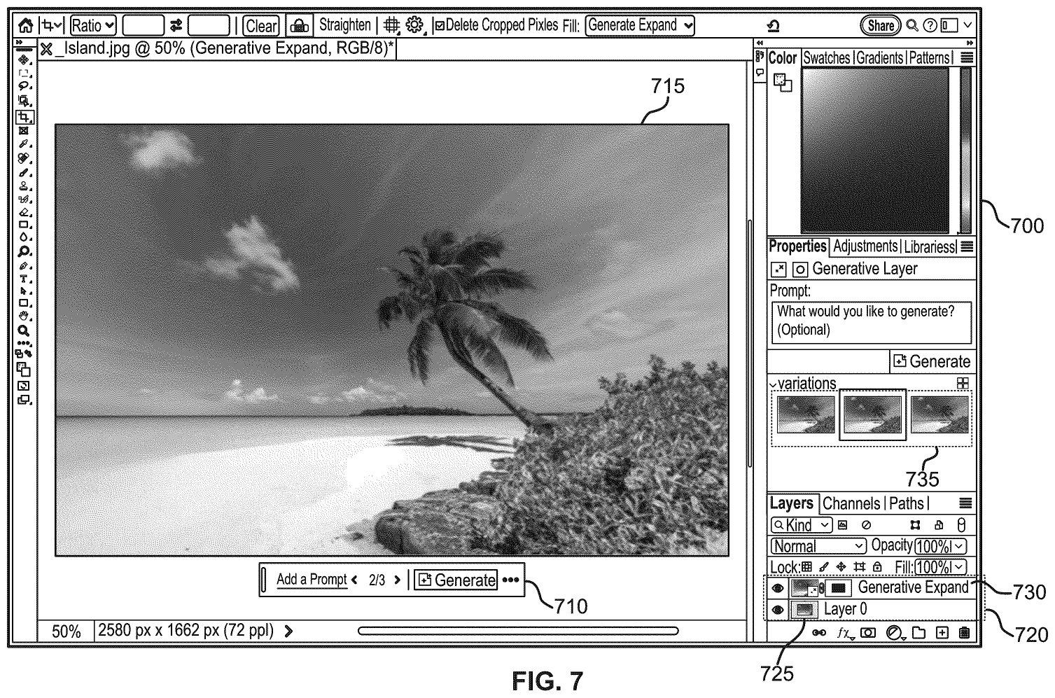

FIG. 7 shows an example of generative expansion according to aspects of the present disclosure. The example shown includes user interface 700, context bar 710, modified image 715, multi-layer image 720, and set of modified images 735. The set of modified images 735 include variations of generated images using a diffusion model. User interface 700 is an example of, or includes aspects of, the corresponding element described with reference to FIGS. 3-6, 8-15, and 17.

According to an embodiment, image generation model 1745 (described with reference to FIG. 17) generates a modified image 715 including original content from the input image in the first region and generated content in the second region.

In some examples, the modified image 715 comprises a multi-layer image 720 including a first layer 725 with the original content and a second layer 730 with the generated content. The original content comprises a pattern and the generated content comprises a repetition of the pattern. As an example shown in FIG. 7, multi-layer image 720 includes first layer 725 and second layer 730.

In some examples, the image generation model 1745 generates a set of modified images 735 based on the input image. The set of modified images 735 are displayed in user interface 700 for selection. User interface 700 presents the set of modified images 735 on the right-hand side of user interface 700 (i.e., variations of generated images from image generation model for user selection). The modified image 715 (displayed in the middle of user interface 700) is selected from the set of modified images 735. User interface 700 displays a preview for each of the set of modified images 735, where the modified image 715 is selected based on the preview. For example, three variations/previews are presented. A user selects the second modified image.

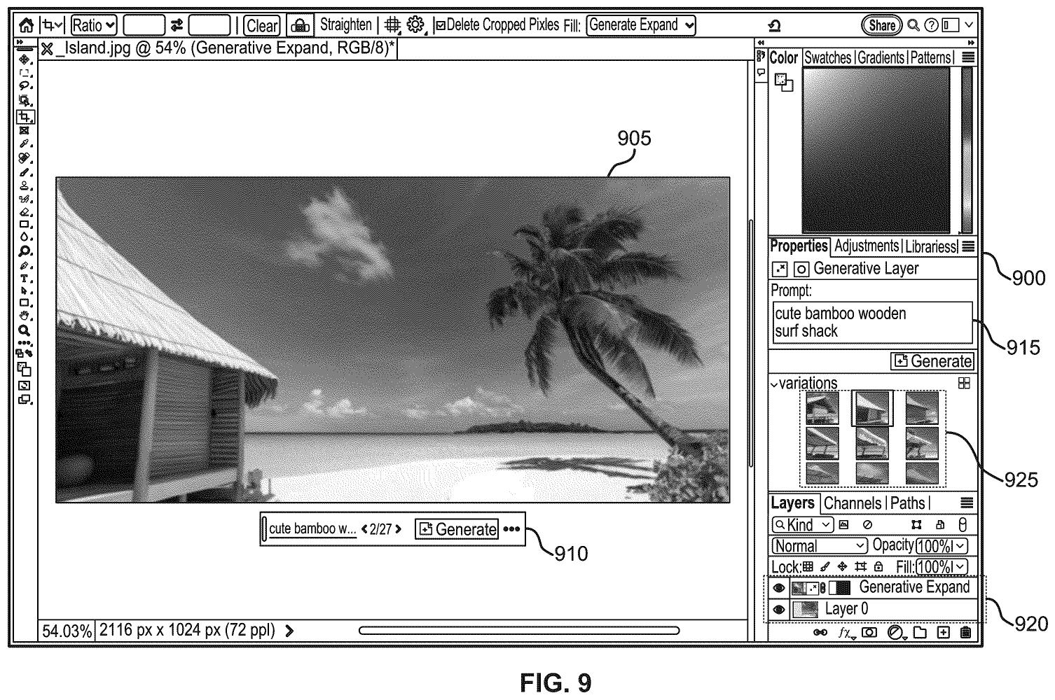

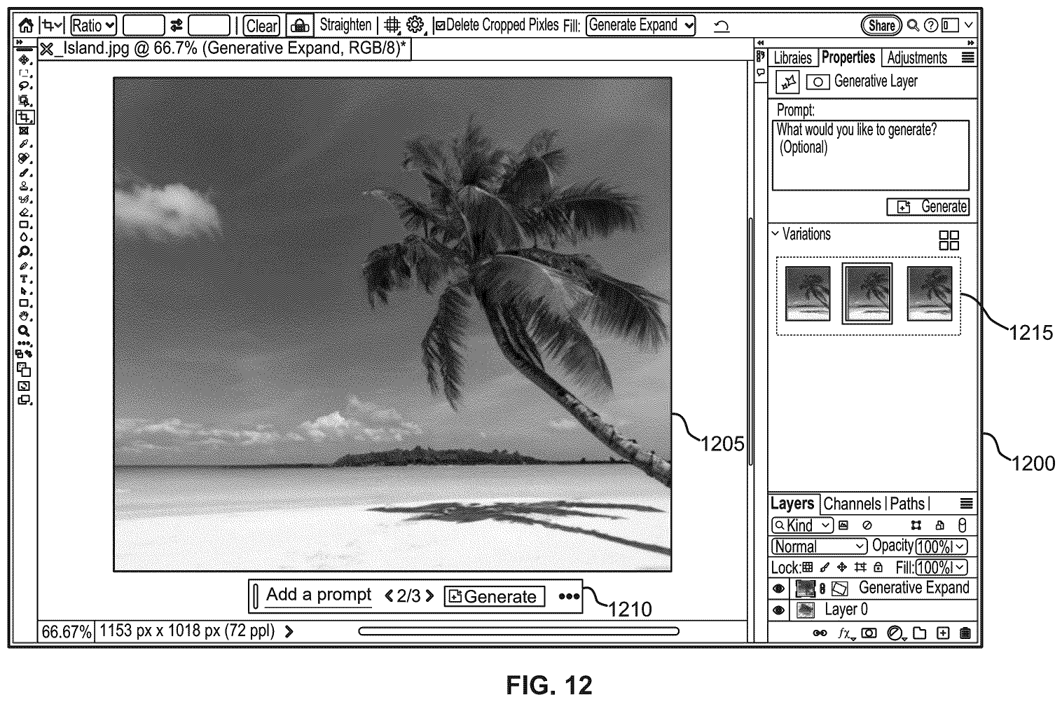

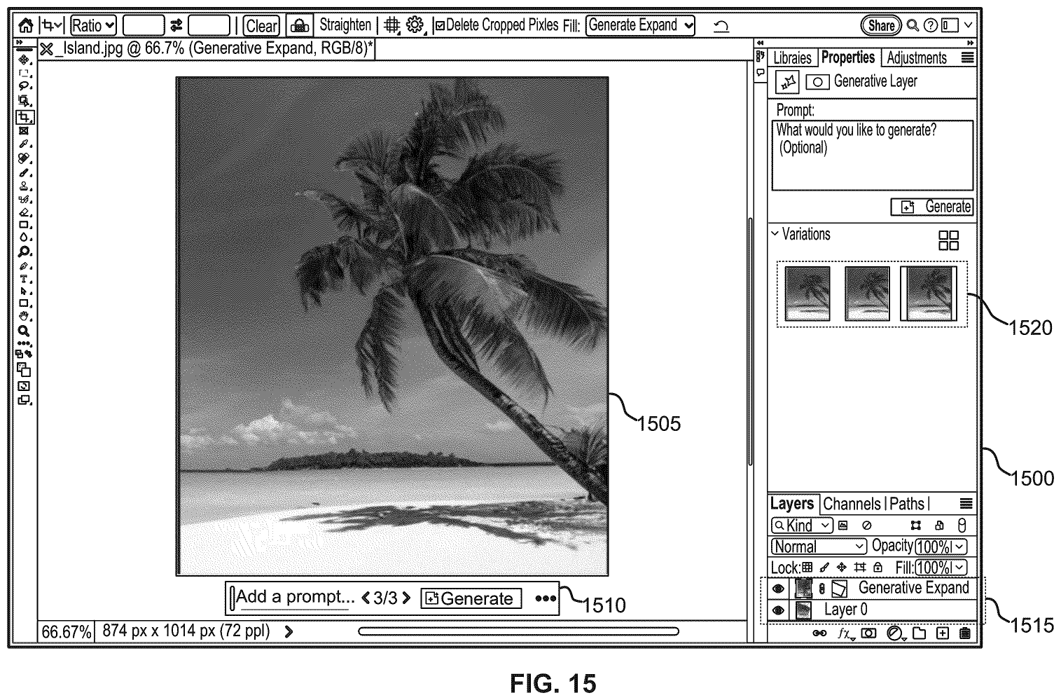

Context bar 710 is an example of, or includes aspects of, the corresponding element described with reference to FIGS. 3-6, 8-15, and 17-20. Modified image 715 is an example of, or includes aspects of, the corresponding element described with reference to FIGS. 12 and 15. Multi-layer image 720 is an example of, or includes aspects of, the corresponding element described with reference to FIGS. 9 and 15. The set of modified images 735 is an example of, or includes aspects of, the corresponding element described with reference to FIGS. 9, 12, and 15.

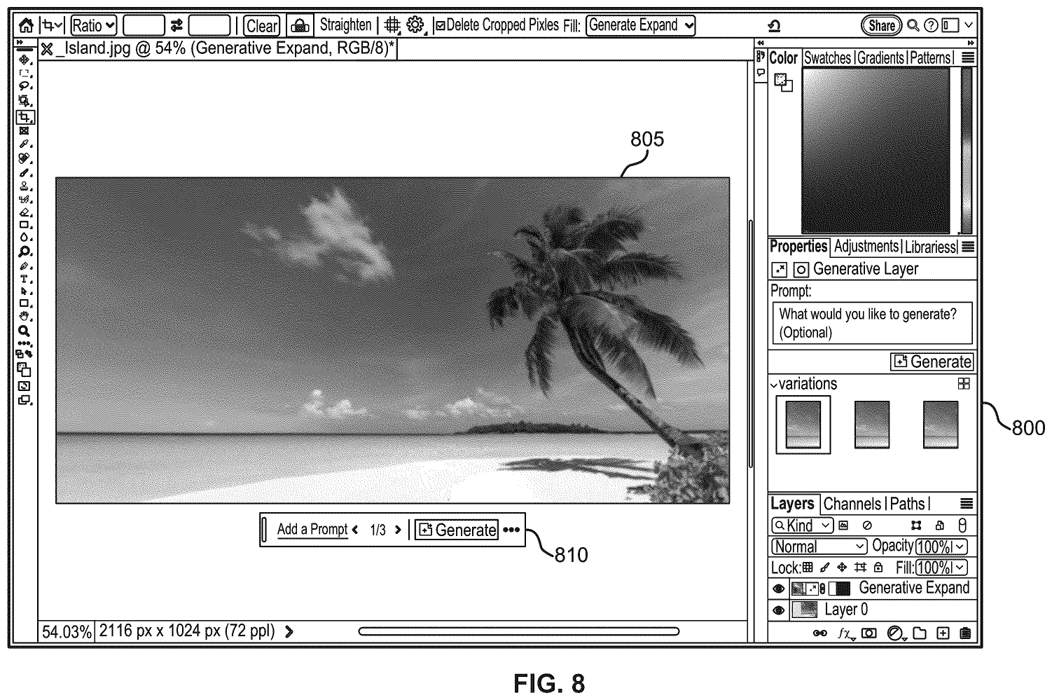

FIG. 8 shows an example of expansion without a prompt according to aspects of the present disclosure. The example shown includes user interface 800, synthetic image 805, and context bar 810. User interface 800 is an example of, or includes aspects of, the corresponding element described with reference to FIGS. 3-7, 9-15, and 17.

As an example shown in FIG. 8, a dimension of the synthetic image 805 here is different from a dimension of the modified image 715 in FIG. 7. Additionally or alternatively, generated content of the synthetic image 805 here is slightly different from generated content of the modified image 715 in FIG. 7 (i.e., ensure diversity in generated content). Generated content of both images shown in FIGS. 7-8 are consistent with respective original content of the input image (i.e., ensure consistency between generated content and original content).

Synthetic image 805 is an example of, or includes aspects of, the corresponding element described with reference to FIG. 9. Context bar 810 is an example of, or includes aspects of, the corresponding element described with reference to FIGS. 3-7, 9-15, and 17-20.

FIG. 9 shows an example of expansion with a prompt according to aspects of the present disclosure. The example shown includes user interface 900, synthetic image 905, context bar 910, text input 915, multi-layer image 920, and set of modified images 925. User interface 900 is an example of, or includes aspects of, the corresponding element described with reference to FIGS. 3-8, 10-15, and 17.

In some examples, user interface 900 receives a text input 915, where the generated content is based on the text input 915. In some examples, user interface 900 provides a context bar 910 (e.g., the context bar 910 is located next to the frame). In some examples, user interface 900 receives a guidance input via the context bar 910, where the generated content is based on the guidance input. The guidance text input 915 is “cute bamboo wooden surf shack”. In some examples, the context bar 910 displays a token indicating the guidance input. In some examples, the prompt inside context bar 910 is identical to text input 915 displayed on the right-hand side of user interface 900.

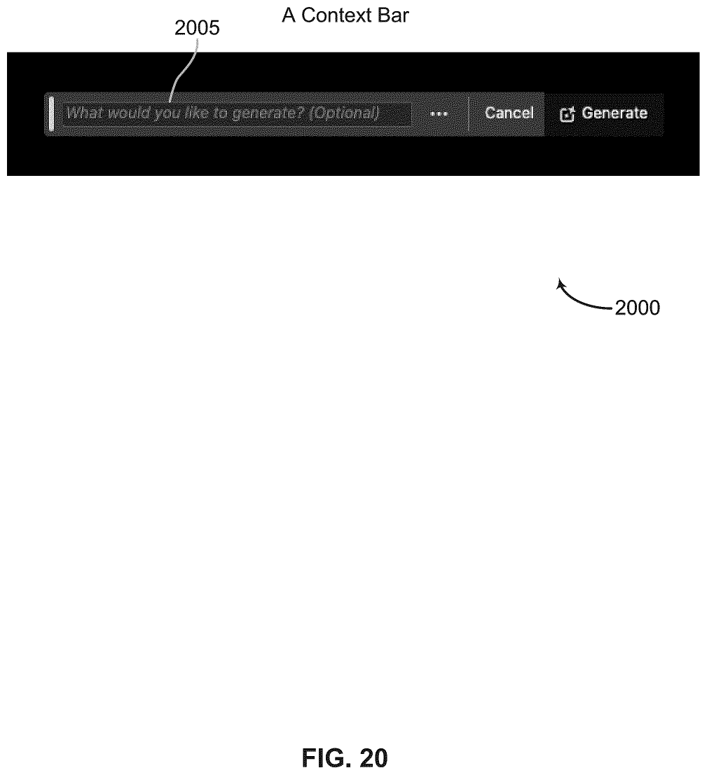

Synthetic image 905 is an example of, or includes aspects of, the corresponding element described with reference to FIG. 8. Context bar 910 is an example of, or includes aspects of, the corresponding element described with reference to FIGS. 3-8, 10-15, and 17-20. Text input 915 is an example of, or includes aspects of, the corresponding element described with reference to FIG. 20. Multi-layer image 920 is an example of, or includes aspects of, the corresponding element described with reference to FIGS. 7 and 15. The set of modified images 925 is an example of, or includes aspects of, the corresponding element described with reference to FIGS. 7, 12, and 15.

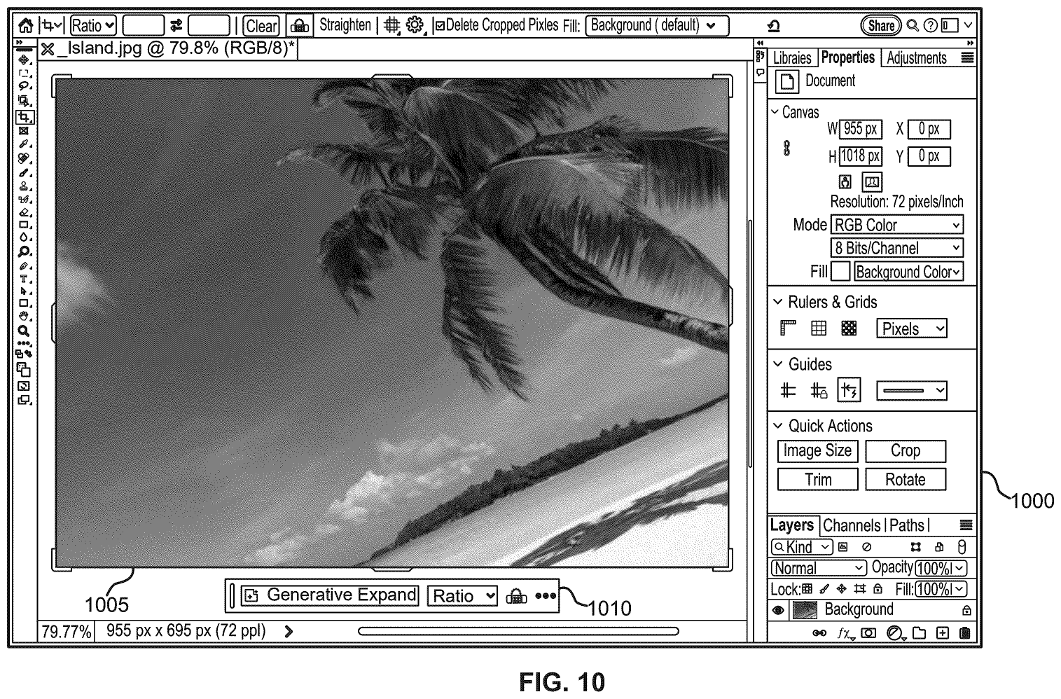

FIG. 10 shows an example of expansion and rotation according to aspects of the present disclosure. The example shown includes user interface 1000, input image 1005, and context bar 1010. User interface 1000 is an example of, or includes aspects of, the corresponding element described with reference to FIGS. 3-9, 11-15, and 17.

FIG. 10 shows an example of user interface 1000 before performing generative expansion. In the middle of the user interface 1000 is an input image 1005. The input image 1005 includes a single layer, as illustrated at the right bottom region of the user interface 1000 (denoted as a “background” layer).

In some examples, a context bar 1010 is located at the bottom of the user interface 1000. The context bar 1010 includes a generative expand element (e.g., “Generative Expand” clickable field located on the left of the context bar 1010). In some cases, a user provides a generative expand input via the generative expand element by clicking on “Generative Expand”. Upon receiving the generative expand input, the backend image generation model (described with reference to FIG. 17) initiates a generative expand mode, receives user input indicating a frame, and generates a modified image inside the frame based on the input image 1005 and the user input.

Input image 1005 is an example of, or includes aspects of, the corresponding element described with reference to FIGS. 3-7, and 13. Context bar 1010 is an example of, or includes aspects of, the corresponding element described with reference to FIGS. 3-9, 11-15, and 17-20.

FIG. 11 shows an example of expansion and rotation according to aspects of the present disclosure. The example shown includes user interface 1100, rotated input image 1105, context bar 1110, cropping tool 1115, and preview 1120. User interface 1100 is an example of, or includes aspects of, the corresponding element described with reference to FIGS. 3-10, 12-15, and 17.

FIG. 11 shows an example of user interface 1100 before performing generative expansion of an input image with reference to FIG. 10. In some cases, the input image is rotated for generative expansion, as is shown here. For example, the input image is rotated to ensure that the sea level in the input image 1105 is horizontal. In some cases, a user specifies a frame indicating the outer boundary of the generative expansion using a cropping tool 1115. In some cases, the user-specified frame encompasses a first region including a rotated input image 1105, and a second region including a blank region outside of the rotated input image 1105. In some cases, the four corners of the rotated input image 1105 are at the edges of the user-specified frame, and the blank region outside of the rotated input image 1105 includes four triangle-shaped blank regions at four corners of the frame (e.g., shown in grey meshes).

In some examples, user interface 1100 rotates the input image, where the original content from the input image is oriented differently in the modified image than in the input image based on the rotation. In some examples, user interface 1100 identifies a target orientation based on content of the input image, where the input image is rotated based on the target orientation.

In some examples, a frame (i.e., an area selected or indicated by cropping tool 1115) includes at least a portion of the rotated input image 1105, wherein the rotated input image 1105 is arranged at an oblique angle with respect to the frame. The user interface 1100 receives a preliminary image and a rotation command indicating the oblique angle. The preliminary image is rotated based on the rotation command to obtain the rotated input image 1105.

Rotated input image 1105 is an example of, or includes aspects of, the corresponding element described with reference to FIG. 14. Context bar 1110 is an example of, or includes aspects of, the corresponding element described with reference to FIGS. 3-10, 12-15, and 17-20. Cropping tool 1115 is an example of, or includes aspects of, the corresponding element described with reference to FIGS. 4-6, 14, and 17. Preview 1120 is an example of, or includes aspects of, the corresponding element described with reference to FIG. 6.

Accordingly, embodiments include obtaining an input image; rotating the input image to obtain a rotated input image at a first angle; obtaining a frame including at least a portion of the input image and arranged at a second angle different from the first angle; generating, using an image generation model, a modified image including original content from the input image and generated content within a portion of the frame outside the input image; and presenting the modified image for display in the user interface. For example, the modified image can be generated to expand the input image to fill the frame.

Some embodiments include obtaining an input image and a frame including at least a portion of the input image, wherein the input image is arranged at an oblique angle with respect to the frame; generating, using an image generation model, a modified image including original content from the input image and generated content within a portion of the frame outside the input image; and presenting the modified image for display in the user interface.

FIG. 12 shows an example of expansion and rotation according to aspects of the present disclosure. The example shown includes user interface 1200, modified image 1205, context bar 1210, and set of modified images 1215. User interface 1200 is an example of, or includes aspects of, the corresponding element described with reference to FIGS. 3-11, 13-15, and 17.

FIG. 12 shows an example of user interface 1200 after performing generative expansion of an input image based on a rotation operation and a user-specified frame in relation to FIGS. 10-12.

In the middle of the user interface 1200 is a modified image 1205 after generative expansion. The image generation model generates the modified image 1205 inside a user-specified frame, which encompasses a first region including a rotated input image, and a second region including a blank region outside of the rotated input image. The modified image 1205 includes original content from the rotated input image in the first region and generated content in the second region. In some cases, the image generation model generates the modified image 1205 based on an optional text prompt, where the generative content is based on the text prompt.

In some examples, the image generation model generates a set of modified images 1215 (e.g., three modified images) based on the input image and displays a preview for each of the modified images at the right-hand side of the user interface 1400. A user selects one of the set of modified images 1215, and the selected modified image is displayed in the middle of the user interface 1200.

The modified image 1205 is a multi-layer image, including a first layer with the original content and a second layer with the generated content. Layers of the image file and preview images for each layer are displayed at the right bottom of the user interface 1200. An example of the first layer is “Layer 0”. “Layer 0” includes the region specified by the frame, in which the rotated input image and a blank region are included. An example of the second layer is the “Generative Expand” layer. The “Generative Expand” layer includes the modified image 1205 generated by the image generation model and a mask indicating the first region and the second region of the user-specified frame. A star-shaped symbol at the right bottom corner of the preview image for the modified image 1205 indicates that the modified image 1205 is generated by the image generation model.

Modified image 1205 is an example of, or includes aspects of, the corresponding element described with reference to FIGS. 7 and 15. Context bar 1210 is an example of, or includes aspects of, the corresponding element described with reference to FIGS. 3-11, 13-15, and 17-20. The set of modified images 1215 is an example of, or includes aspects of, the corresponding element described with reference to FIGS. 7, 9, and 15.

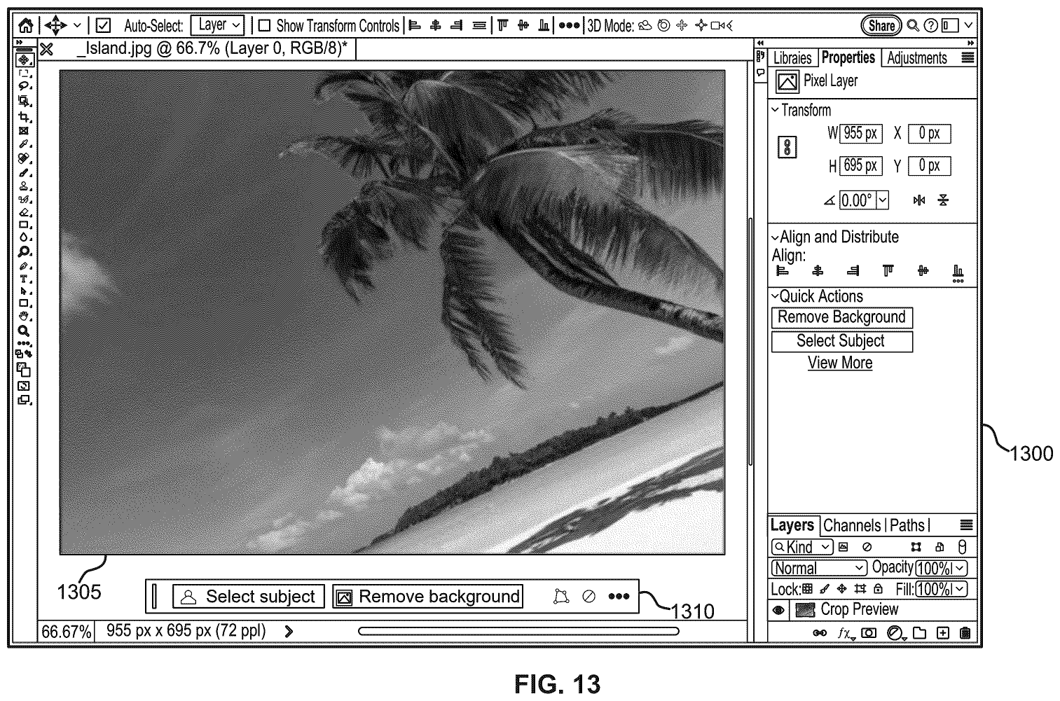

FIG. 13 shows an example of a sequence of image editing operations according to aspects of the present disclosure. The example shown includes user interface 1300, input image 1305, and context bar 1310. User interface 1300 is an example of, or includes aspects of, the corresponding element described with reference to FIGS. 3-12, 14, 15, and 17.

FIG. 13 shows an example of user interface 1300 before performing generative expansion. In the middle of the user interface 1300 is an input image 1305. The input image 1305 corresponds to a single layer denoted as “background” layer, as illustrated at the right-bottom region of the user interface 1300. A context bar 1310 is located at the bottom area of user interface 1300. The context bar 1310 includes a generative expand element. In some cases, a user provides a generative expand input via the generative expand element via mouse clicks. Upon receiving the generative expand input, the backend image generation model initiates a generative expand mode, receives user input indicating a frame, and generates a modified image inside the frame based on the input image 1305 and the user input.

Input image 1305 is an example of, or includes aspects of, the corresponding element described with reference to FIGS. 3-7, and 10. Context bar 1310 is an example of, or includes aspects of, the corresponding element described with reference to FIGS. 3-12, 14, 15, and 17-20.

FIG. 14 shows an example of a sequence of image editing operations according to aspects of the present disclosure. The example shown includes user interface 1400, rotated input image 1405, cropping tool 1410, context bar 1415, first region 1420, second region 1425, and third region 1430. User interface 1400 is an example of, or includes aspects of, the corresponding element described with reference to FIGS. 3-13, 15, and 17.

FIG. 14 shows an example of user interface 1400 before performing generative expansion of an input image with reference to FIG. 13. In some cases, the input image is rotated for generative expansion, as is shown here. For example, the input image is rotated to ensure that the sea level in the input image is horizontal. In some cases, a user specifies a frame indicating the outer boundary of the generative expansion using a cropping tool 1410. In some cases, the user-specified frame encompasses a first region 1420 including a region inside the rotated input image 1405, and a second region 1425 including a blank region outside of the rotated input image 1405. In some cases, the rotated input image 1405 is separated into two or more regions. The first region 1420 of the rotated input image 1405 and the second region 1425 are included in the user-specified frame, and a third region 1430 of the rotated input image 1405 is excluded from the user-specified frame and accordingly not included in the generated image using the image generation model. For example, the blank region outside of the rotated input image 1405 (to be filled with generated content) includes three triangle-shaped blank regions at the corners of the frame.

In some examples, a frame (i.e., an area selected or indicated by cropping tool 1410) includes at least a portion of the rotated input image 1405, wherein the rotated input image 1405 is arranged at an oblique angle with respect to the frame. The user interface 1400 receives a preliminary image and a rotation command indicating the oblique angle. The preliminary image is rotated based on the rotation command to obtain the rotated input image 1405.

Rotated input image 1405 is an example of, or includes aspects of, the corresponding element described with reference to FIG. 11. Cropping tool 1410 is an example of, or includes aspects of, the corresponding element described with reference to FIGS. 4-6, 11, and 17. Context bar 1415 is an example of, or includes aspects of, the corresponding element described with reference to FIGS. 3-13, 15, and 17-20. First region 1420 is an example of, or includes aspects of, the corresponding element described with reference to FIGS. 5 and 6. Second region 1425 is an example of, or includes aspects of, the corresponding element described with reference to FIGS. 5 and 6. Third region 1430 is an example of, or includes aspects of, the corresponding element described with reference to FIG. 5.

FIG. 15 shows an example of a sequence of image editing operations according to aspects of the present disclosure. The example shown includes user interface 1500, modified image 1505, context bar 1510, multi-layer image 1515, and set of modified images 1520. User interface 1500 is an example of, or includes aspects of, the corresponding element described with reference to FIGS. 3-14, and 17.

FIG. 15 shows an example of user interface 1500 after performing generative expansion of an input image based on a rotation operation and a user-specified frame with reference to FIGS. 13-14.

In the middle of the user interface 1500 is a modified image 1505 generated by an image generation model. The image generation model generates the modified image 1505 inside a user-specified frame, which encompasses a first region inside a rotated input image and a second region (or blank region) outside of the rotated input image. The modified image 1505 includes original content from the rotated input image in the first region and generated content in the second region. In some cases, the image generation model generates the modified image 1505 based on an optional text prompt.

In some examples, the image generation model generates a set of modified images 1520 (e.g., 3 modified images) based on the input image and displays a preview for each of the modified images at the right-hand side of the user interface 1500. A user selects one of the set of modified images 1520, and the selected modified image is displayed in the middle of the user interface 1500.

The user interface 1500 is configured to present a multi-layer image 1515, including a first layer with the original content and a second layer with the generated content. Layers of the multi-layer image 1515 and preview images for each layer are displayed at the right-bottom of the user interface 1500. For example, the first layer is referred to as “Layer 0”. “Layer 0” includes a region specified by the frame, in which a region inside the rotated input image and a blank region are included. A second layer is referred to as the “Generative Expand” layer. The “Generative Expand” layer includes the modified image 1505 generated by the image generation model and a mask indicating the first region and the second region of the user-specified frame. A star-shaped symbol at the right-bottom corner of the preview image for the modified image 1505 indicates that the modified image 1505 is generated by the image generation model.

Modified image 1505 is an example of, or includes aspects of, the corresponding element described with reference to FIGS. 7 and 12. Context bar 1510 is an example of, or includes aspects of, the corresponding element described with reference to FIGS. 3-14, and 17-20. Multi-layer image 1515 is an example of, or includes aspects of, the corresponding element described with reference to FIGS. 7 and 9. The set of modified images 1520 is an example of, or includes aspects of, the corresponding element described with reference to FIGS. 7, 9, and 12.

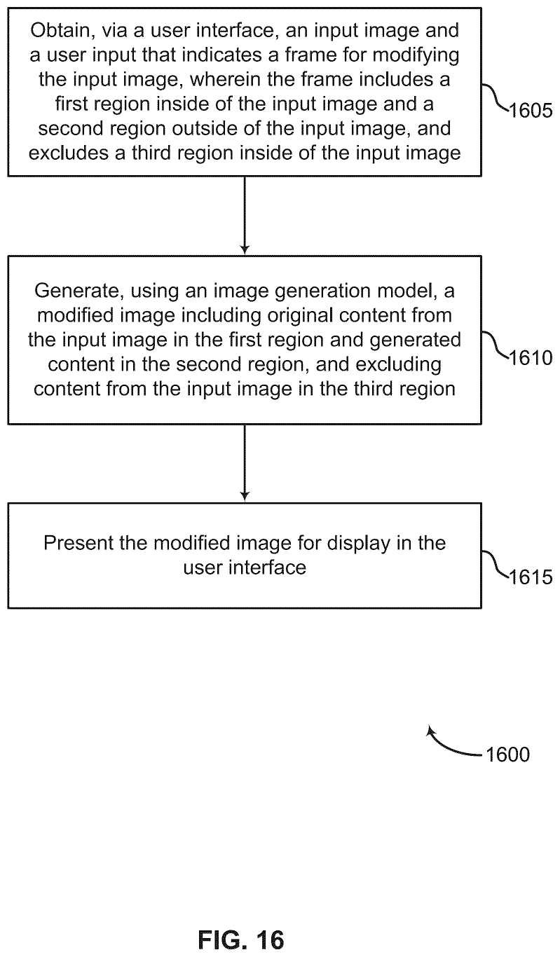

FIG. 16 shows an example of a method 1600 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various sub-steps or are performed in conjunction with other operations.

At operation 1605, the system obtains, via a user interface an input image and a user input that indicates a frame including a first region inside of the input image and a second region outside of the input image and excluding a third region inside of the input image (i.e., a frame for modifying the input image). In some cases, the operations of this step refer to, or may be performed by, a user interface as described with reference to FIGS. 3-15, and 17.

In some examples, a user drags a cropping tool in the user interface to indicate a frame having target dimensions. The user input, via the cropping tool, indicates a frame including a first region inside of the input image (or equivalent to the input image) and a second region outside of the input image. Additionally or alternatively, the user input indicates a frame excluding a third region inside of the input image. In some cases, the user input indicates a frame that expands all four sides of the input image.

At operation 1610, the system generates, using an image generation model, a modified image including original content from the input image in the first region and generated content in the second region, and excluding content from the input image in the third region. In some cases, the operations of this step refer to, or may be performed by, an image generation model as described with reference to FIG. 17.

In some examples, the image generation model includes a diffusion model that is trained to generate one or more outpainting regions (e.g., the second region outside of the input image). The style of the outpainting region (the second region) is consistent with the style of the input image (or the first region inside of the input image).

At operation 1615, the system presents the modified image for display in the user interface. In some cases, the operations of this step refer to, or may be performed by, a user interface as described with reference to FIGS. 3-15, and 17.

In FIGS. 1-16, a method, apparatus, and non-transitory computer readable medium for image processing are described. One or more embodiments of the method, apparatus, and non-transitory computer readable medium include obtaining, via a user interface an input image and a user input that indicates a frame including a first region inside of the input image and a second region outside of the input image, and excluding a third region inside of the input image; generating, using an image generation model, a modified image including original content from the input image in the first region and generated content in the second region, and excluding content from the input image in the third region; and presenting the modified image for display in the user interface.

Some examples of the method, apparatus, and non-transitory computer readable medium further include providing a cropping tool to a user. Some examples further include receiving a drag input via the cropping tool, wherein the frame is based on the drag input. Some examples of the method, apparatus, and non-transitory computer readable medium further include rotating the input image, wherein the original content from the input image is oriented differently in the modified image than in the input image based on the rotation. Some examples of the method, apparatus, and non-transitory computer readable medium further include identifying a target orientation based on content of the input image, wherein the input image is rotated based on the target orientation.

Some examples of the method, apparatus, and non-transitory computer readable medium further include providing a generative expand element in a user interface. Some examples further include receiving a generative expand input via the generative expand element. Some examples further include initiating a generative expand mode based on the generative expand input, wherein the modified image is generated based on the generative expand mode. Some examples of the method, apparatus, and non-transitory computer readable medium further include receiving a text input, wherein the image generation model generates the modified image based on the text input.

Some examples of the method, apparatus, and non-transitory computer readable medium further include providing a context bar in a user interface at a location based on the input image. Some examples further include receiving a guidance input via the context bar, wherein the generated content is based on the guidance input. In some examples, the context bar displays a token indicating a category of the guidance input. In some examples, the user input comprises a selection of a preset image aspect ratio. Some examples of the method, apparatus, and non-transitory computer readable medium further include generating a multi-layer image including a first layer with the original content and a second layer with the generated content.

In some examples, the original content comprises a pattern and the generated content comprises a repetition of the pattern. Some examples of the method, apparatus, and non-transitory computer readable medium further include receiving a pattern expansion selection indicating a pattern expansion option from a plurality of pattern expansion options including a generative expansion option and an algorithmic expansion option. Some examples of the method, apparatus, and non-transitory computer readable medium further include generating a plurality of modified images using the image generation model based on the input image, wherein the modified image is selected from the plurality of modified images. Some examples of the method, apparatus, and non-transitory computer readable medium further include displaying a preview for each of the plurality of modified images, wherein the modified image is selected based on the preview.

One or more embodiments of the method, apparatus, and non-transitory computer readable medium include obtaining an input image and a frame including at least a portion of the input image, wherein the input image is arranged at an oblique angle with respect to the frame; generating, using an image generation model, a modified image including original content from the input image and generated content within a portion of the frame outside the input image; and presenting the modified image for display in a user interface. Some examples of the method, apparatus, and non-transitory computer readable medium further include receiving a preliminary image; receiving a rotation command indicating the oblique angle; and rotating the preliminary image based on the rotation command to obtain the input image.

### Network Architecture

FIG. 17 shows an example of an image processing apparatus 1700 according to aspects of the present disclosure. The example shown includes image processing apparatus 1700, processor unit 1705, I/O module 1710, memory unit 1715, image processing model 1720, user interface 1725, image generation model 1745, and training component 1750. Image processing apparatus 1700 is an example of, or includes aspects of, the corresponding element described with reference to FIG. 1.

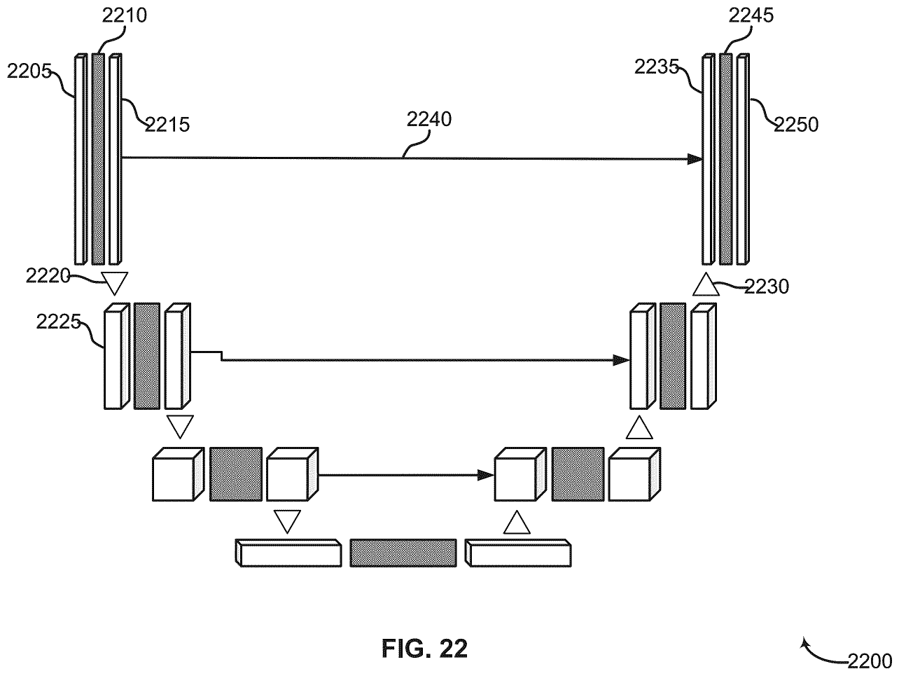

Image processing apparatus 1700 may include an example of, or aspects of, the guided diffusion model described with reference to FIG. 21 and the U-Net described with reference to FIG. 22. In some embodiments, image processing apparatus 1700 includes processor unit 1705, I/O module 1710, memory unit 1715, image processing model 1720, and training component 1750. Training component 1750 updates parameters of the image processing model 1720 stored in memory unit 1715. In some examples, the training component 1750 is located outside the image processing apparatus 1700.

Processor unit 1705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

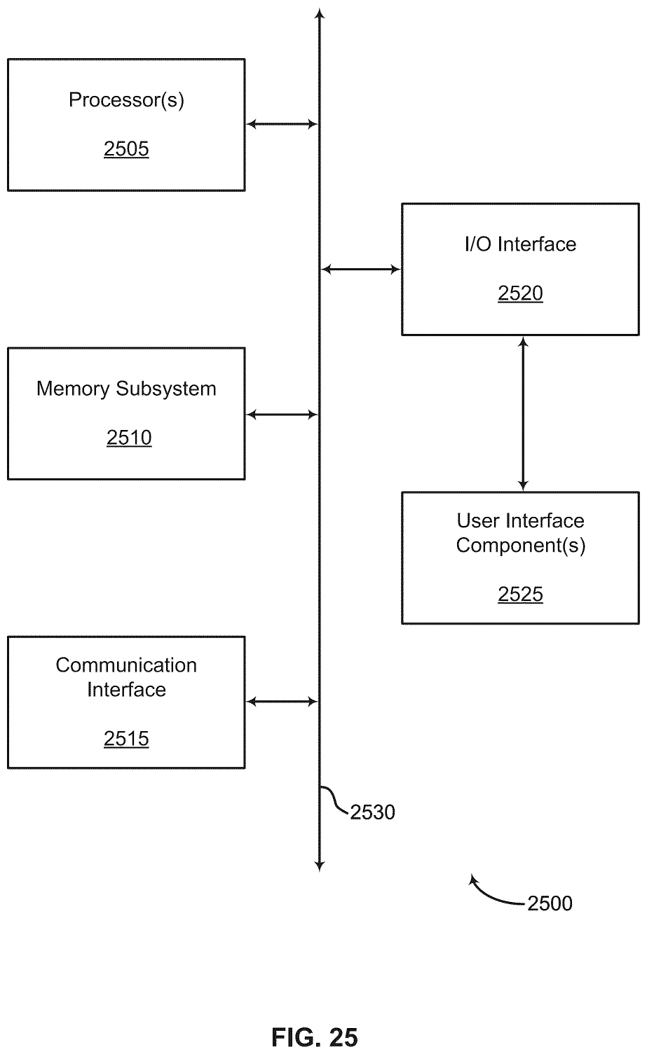

In some cases, processor unit 1705 is configured to operate a memory array using a memory controller. In other cases, a memory controller is integrated into processor unit 1705. In some cases, processor unit 1705 is configured to execute computer-readable instructions stored in memory unit 1715 to perform various functions. In some aspects, processor unit 1705 includes special purpose components for modem processing, baseband processing, digital signal processing, or transmission processing. According to some aspects, processor unit 1705 comprises one or more processors described with reference to FIG. 25.

Memory unit 1715 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1705 to perform various functions described herein.

In some cases, memory unit 1715 includes a basic input/output system (BIOS) that controls basic hardware or software operations, such as an interaction with peripheral components or devices. In some cases, memory unit 1715 includes a memory controller that operates memory cells of memory unit 1715. For example, the memory controller may include a row decoder, column decoder, or both. In some cases, memory cells within memory unit 1715 store information in the form of a logical state. According to some aspects, memory unit 1715 is an example of the memory subsystem 2510 described with reference to FIG. 25.

According to some embodiments, image processing apparatus 1700 uses one or more processors of processor unit 1705 to execute instructions stored in memory unit 1715 to perform functions described herein. For example, image processing apparatus 1700 may obtain, via a user interface, an input image and a user input that indicates a frame including a first region inside of the input image and a second region outside of the input image, and excluding a third region inside of the input image. Image processing apparatus 1700 generates, using an image generation model, a modified image including original content from the input image in the first region and generated content in the second region, and excluding content from the input image in the third region.

The memory unit 1715 may include an image processing model 1720 trained to obtain, via a user interface, an input image and a user input that indicates a frame including a first region inside of the input image and a second region outside of the input image, and excluding a third region inside of the input image; generate, using an image generation model, a modified image including original content from the input image in the first region and generated content in the second region, and excluding content from the input image in the third region; and present the modified image for display in the user interface. For example, image processing model 1720 is a pre-trained model and may perform inferencing operations as described with reference to FIGS. 2, 16 and 23.

In some embodiments, the image processing model 1720 is an artificial neural network (ANN) such as the guided diffusion model described with reference to FIG. 21 and the U-Net described with reference to FIG. 22. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of image processing model 1720 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1750 may train the image processing model 1720. For example, parameters of the image processing model 1720 can be learned or estimated from training data and then used to make predictions or perform tasks based on learned patterns and relationships in the data. In some examples, the parameters are adjusted during the training process to minimize a loss function or maximize a performance metric. The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model can be used to make predictions on new, unseen data (i.e., during inference).

I/O module 1710 receives inputs from and transmits outputs of the image processing apparatus 1700 to other devices or users. For example, I/O module 1710 receives inputs for the image processing model 1720 and transmits outputs of the image processing model 1720. According to some aspects, I/O module 1710 is an example of the I/O interface 2520 described with reference to FIG. 25.

In one embodiment, image processing model 1720 includes user interface 1725 and image generation model 1745. Image processing model 1720 is an example of, or includes aspects of, the corresponding element described with reference to FIGS. 21-22.

According to some embodiments, image processing model 1720 generates a multi-layer image including a first layer with the original content and a second layer with the generated content. In some examples, the original content includes a pattern and the generated content includes a repetition of the pattern.

In one embodiment, user interface 1725 includes cropping tool 1730, generative expand element 1735, and context bar 1740. User interface 1725 is an example of, or includes aspects of, the corresponding element described with reference to FIGS. 3-15.

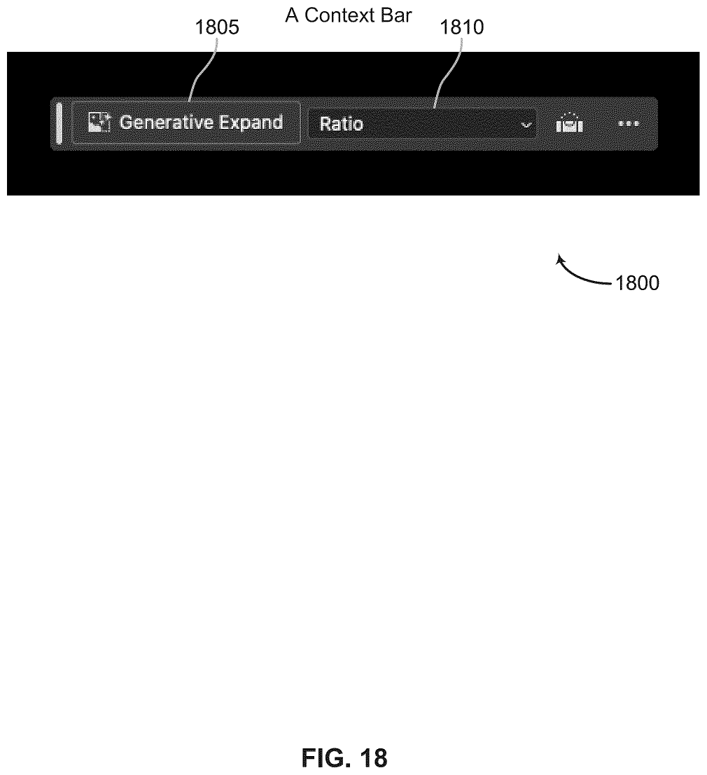

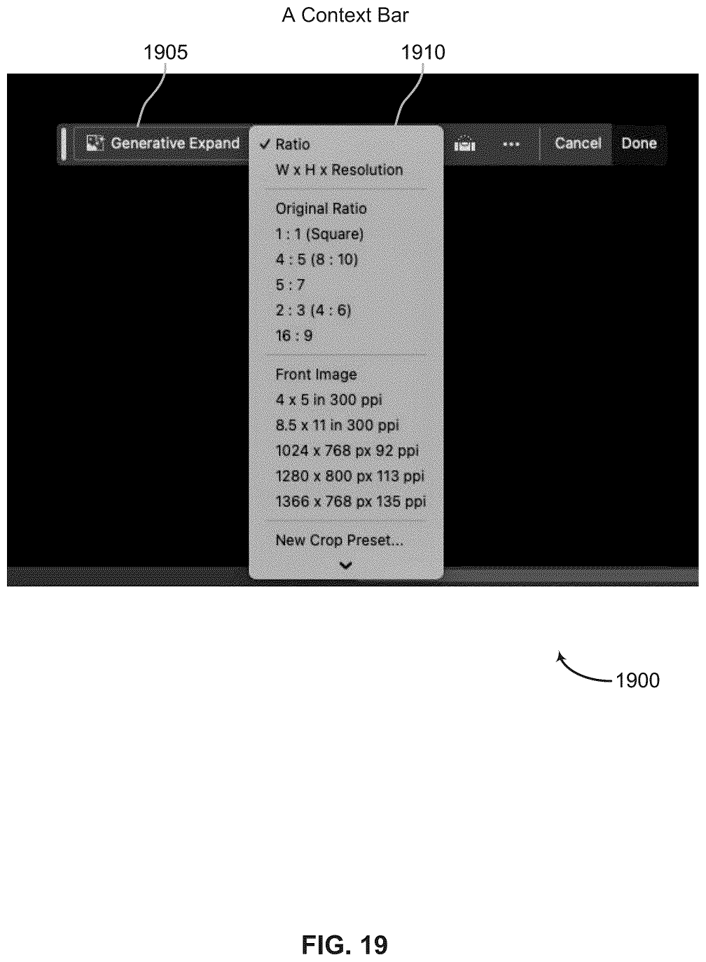

Cropping tool 1730 is an example of, or includes aspects of, the corresponding element described with reference to FIGS. 4-6, 11, and 14. Generative expand element 1735 is an example of, or includes aspects of, the corresponding element described with reference to FIGS. 18 and 19. Context bar 1740 is an example of, or includes aspects of, the corresponding element described with reference to FIGS. 3-15, and 18-20.

According to some embodiments, image generation model 1745 generates a modified image including original content from the input image in the first region and generated content in the second region, and excluding content from the input image in the third region. In some examples, image generation model 1745 receives a text input, where the image generation model 1745 generates the modified image based on the text input. In some examples, image generation model 1745 generates a set of modified images based on the input image, where the modified image is selected from the set of modified images. In some examples, the image generation model 1745 includes a diffusion U-Net architecture.

FIG. 18 shows an example of a context bar 1800 according to aspects of the present disclosure. The example shown includes context bar 1800, generative expand element 1805, and image aspect ratio element 1810.

For example, context bar 1800 includes a generative expand element 1805 (e.g., labeled as “Generative Expand” field). Context bar 1800 receives a generative expand input via the generative expand element. The user input comprises a selection of a preset image aspect ratio. Image aspect ratio element 1810 of context bar 1800 receives the selection of an image aspect ratio.

Context bar 1800 is an example of, or includes aspects of, the corresponding element described with reference to FIGS. 3-15, 17, 19, and 20. Generative expand element 1805 is an example of, or includes aspects of, the corresponding element described with reference to FIGS. 17 and 19. Image aspect ratio element 1810 is an example of, or includes aspects of, the corresponding element described with reference to FIG. 19.

FIG. 19 shows an example of a context bar 1900 according to aspects of the present disclosure. The example shown includes context bar 1900, generative expand element 1905, and image aspect ratio element 1910. In an embodiment, context bar 1900 includes generative expand element 1905 and image aspect ratio element 1910.

In some examples, the user input includes a selection of a preset image aspect ratio (e.g., 1:1, 4:5, 5:7, 2:3, 16:9 aspect ratio). Additionally, the user input includes width-by-height resolution (e.g., W×H resolution such as 1024×768, 1280×800, 1366×768).

Context bar 1900 is an example of, or includes aspects of, the corresponding element described with reference to FIGS. 3-15, 17, 18, and 20. Generative expand element 1905 is an example of, or includes aspects of, the corresponding element described with reference to FIGS. 17 and 18. Image aspect ratio element 1910 is an example of, or includes aspects of, the corresponding element described with reference to FIG. 18.

FIG. 20 shows an example of a context bar 2000 according to aspects of the present disclosure. The example shown includes context bar 2000 and text input 2005. Context bar 2000 receives a text input 2005, wherein the generated content is based on the text input 2005. The text input is optional. A preset indicator of the text prompt field displays “what would you like to generate? (optional)”.

Context bar 2000 is an example of, or includes aspects of, the corresponding element described with reference to FIGS. 3-15, and 17-19. Text input 2005 is an example of, or includes aspects of, the corresponding element described with reference to FIG. 9.

FIG. 21 shows an example of a guided diffusion model according to aspects of the present disclosure. The guided latent diffusion model 2100 depicted in FIG. 21 is an example of, or includes aspects of, the corresponding element (i.e., image processing model 1720) described with reference to FIG. 17.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 2100 may take an original image 2105 in a pixel space 2110 as input and apply and image encoder 2115 to convert original image 2105 into original image features 2120 in a latent space 2125. Then, a forward diffusion process 2130 gradually adds noise to the original image features 2120 to obtain noisy features 2135 (also in latent space 2125) at various noise levels.

Next, a reverse diffusion process 2140 (e.g., a U-Net ANN) gradually removes the noise from the noisy features 2135 at the various noise levels to obtain denoised image features 2145 in latent space 2125. In some examples, the denoised image features 2145 are compared to the original image features 2120 at each of the various noise levels, and parameters of the reverse diffusion process 2140 of the diffusion model are updated based on the comparison. Finally, an image decoder 2150 decodes the denoised image features 2145 to obtain an output image 2155 in pixel space 2110. In some cases, an output image 2155 is created at each of the various noise levels. The output image 2155 can be compared to the original image 2105 to train the reverse diffusion process 2140.

In some cases, image encoder 2115 and image decoder 2150 are pre-trained prior to training the reverse diffusion process 2140. In some examples, image encoder 2115 and image decoder 2150 are trained jointly, or the image encoder 2115 and image decoder 2150 and fine-tuned jointly with the reverse diffusion process 2140.

The reverse diffusion process 2140 can also be guided based on a text prompt 2160, or another guidance prompt, such as an image, a layout, a segmentation map, etc. The text prompt 2160 can be encoded using a text encoder 2165 (e.g., a multimodal encoder) to obtain guidance features 2170 in guidance space 2175. The guidance features 2170 can be combined with the noisy features 2135 at one or more layers of the reverse diffusion process 2140 to ensure that the output image 2155 includes content described by the text prompt 2160. For example, guidance features 2170 can be combined with the noisy features 2135 using a cross-attention block within the reverse diffusion process 2140.

FIG. 22 shows an example of a U-Net 2200 architecture according to aspects of the present disclosure. In some examples, U-Net 2200 is an example of the component that performs the reverse diffusion process 2140 of guided latent diffusion model 2100 described with reference to FIG. 21 and includes architectural elements of the image processing model 1720 described with reference to FIG. 17. The U-Net 2200 depicted in FIG. 22 is an example of, or includes aspects of, the architecture used within the reverse diffusion process described with reference to FIG. 21.

In some examples, diffusion models are based on a neural network architecture known as a U-Net. The U-Net 2200 takes input features 2205 having an initial resolution and an initial number of channels and processes the input features 2205 using an initial neural network layer 2210 (e.g., a convolutional network layer) to produce intermediate features 2215. The intermediate features 2215 are then down-sampled using a down-sampling layer 2220 such that down-sampled features 2225 have a resolution less than the initial resolution and a number of channels greater than the initial number of channels.

This process is repeated multiple times, and then the process is reversed. That is, the down-sampled features 2225 are up-sampled using up-sampling process 2230 to obtain up-sampled features 2235. The up-sampled features 2235 can be combined with intermediate features 2215 having the same resolution and number of channels via a skip connection 2240. These inputs are processed using a final neural network layer 2245 to produce output features 2250. In some cases, the output features 2250 have the same resolution as the initial resolution and the same number of channels as the initial number of channels.

In some cases, U-Net 2200 takes additional input features to produce conditionally generated output. For example, the additional input features could include a vector representation of an input prompt. The additional input features can be combined with the intermediate features 2215 within the neural network at one or more layers. For example, a cross-attention module can be used to combine the additional input features and the intermediate features 2215.

In FIGS. 17-22, an apparatus and method for image processing are described. One or more embodiments of the apparatus and method include a memory component; a processing device coupled to the memory component, the processing device configured to perform operations comprising; obtaining, via a user interface, a user input that indicates a frame including a first region inside of an input image and a second region outside of the input image, and excluding a third region inside of the input image; and generating, using an image generation model, a modified image including original content from the input image in the first region and generated content in the second region, and excluding content from the input image in the third region.

In some examples, the user interface comprises a cropping tool configured to receive a drag input, wherein the frame is based on the drag input. In some examples, the user interface comprises a generative expand element configured to receive a generative expand input and initiate a generative expand mode based on the generative expand input, wherein the modified image is generated based on the generative expand mode.

In some examples, the user interface comprises a context bar at a location based on the input image and configured to receive a guidance input, wherein the generated content is based on the guidance input. In some examples, the image generation model comprises a diffusion U-Net architecture.

### Generative Expand in Image Editing

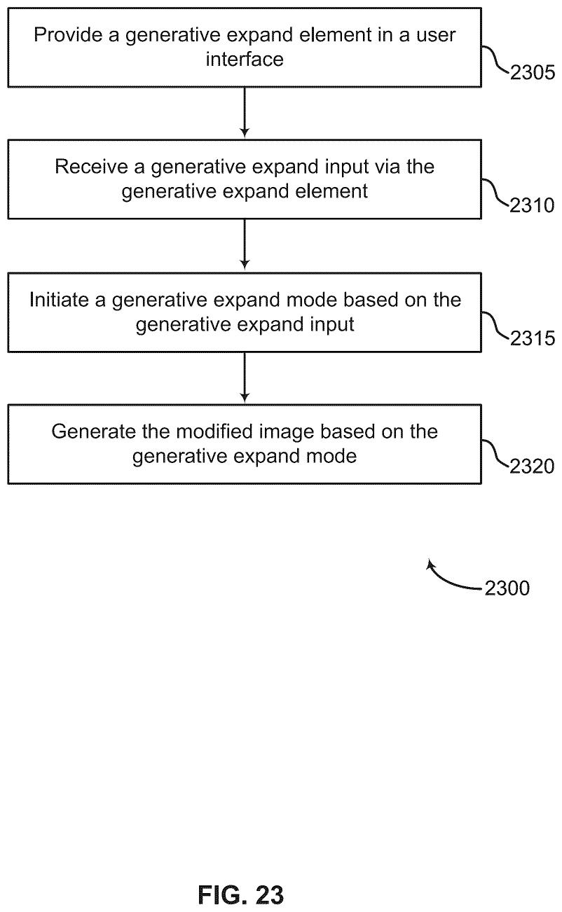

FIG. 23 shows an example of a method 2300 for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various sub-steps, or are performed in conjunction with other operations.

At operation 2305, the system provides a generative expand element in a user interface. In some cases, the operations of this step refer to, or may be performed by, a user interface as described with reference to FIGS. 3-15, and 17. Examples of a generative expand element are described with reference to FIGS. 3, 6, 10, 13 and 17-19.

At operation 2310, the system receives a generative expand input via the generative expand element. In some cases, the operations of this step refer to, or may be performed by, a user interface as described with reference to FIGS. 3-15, and 17.

At operation 2315, the system initiates a generative expand mode based on the generative expand input. In some cases, the operations of this step refer to, or may be performed by, a user interface as described with reference to FIGS. 3-15, and 17.

In some examples, a user clicks on “Generate” button located in a context bar and then image processing model 1720 (with reference to FIG. 17) initiates a generative expand mode based on the generative expand input.

At operation 2320, the system generates the modified image based on the generative expand mode. In some cases, the operations of this step refer to, or may be performed by, an image generation model as described with reference to FIG. 17.

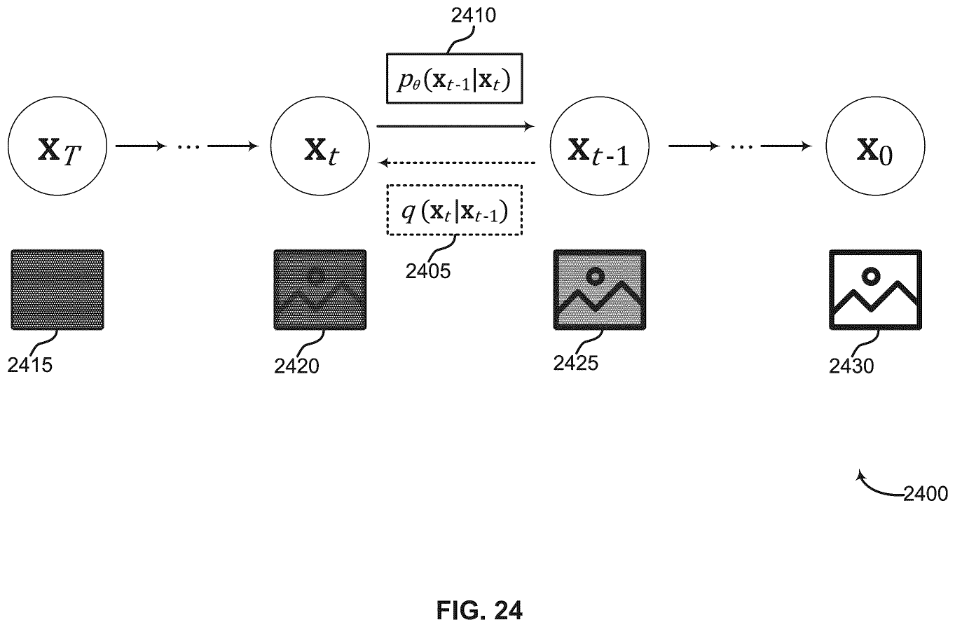

FIG. 24 shows an example of a diffusion process 2400 according to aspects of the present disclosure. In some examples, diffusion process 2400 describes an operation of the image processing model 1720 described with reference to FIG. 17, such as the reverse diffusion process 2140 of guided latent diffusion model 2100 described with reference to FIG. 21.

As described above with reference to FIG. 21, using a diffusion model can involve both a forward diffusion process 2405 for adding noise to a media item (or features in a latent space) and a reverse diffusion process 2410 for denoising the media item (or features) to obtain a denoised media item. The forward diffusion process 2405 can be represented as q(xₜ|xₜ₋₁), and the reverse diffusion process 2410 can be represented as p(xₜ₋₁|xₜ). In some cases, the forward diffusion process 2405 is used during training to generate media items with successively greater noise, and a neural network is trained to perform the reverse diffusion process 2410 (i.e., to successively remove the noise).

In an example forward process for a latent diffusion model, the model maps an observed variable x₀ (either in a pixel space or a latent space) intermediate variables x₁, . . . , X_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 2410, the model begins with noisy data x_{T}, such as a noisy media item 2415 and denoises the data to obtain the p (xₜ₋₁|xₜ). At each step t−1, the reverse diffusion process 2410 takes xₜ, such as first intermediate media item 2420, and t as input. Here, t represents a step in the sequence of transitions associated with different noise levels, The reverse diffusion process 2410 outputs xₜ₋₁, such as second intermediate media item 2425 iteratively until x_{T} reverts back to x₀, the original media item 2430. The reverse process can be represented as:

$${p}_{θ} ( {x}_{t - 1} \vert {x}_{t} ) := N ( {x}_{t - 1} ; {μ}_{θ} ( {x}_{t} , t ) , {Σ}_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where p(x_{T})=N(x_{T};0,1) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At inference time, observed data x₀ in a pixel space can be mapped into a latent space as input and a generated data ã is mapped back into the pixel space from the latent space as output. In some examples, x₀ represents an original input media item with low quality, latent variables x₁, . . . , x_{T} represent noisy media items, and \tilde{x} represents the generated item with high quality.

FIG. 25 shows an example of a computing device 2500 for image processing according to aspects of the present disclosure. The computing device 2500 may be an example of the image processing apparatus 1700 described with reference to FIG. 17. In one aspect, computing device 2500 includes processor(s) 2505, memory subsystem 2510, communication interface 2515, I/O interface 2520, user interface component(s) 2525, and channel 2530.

In some embodiments, computing device 2500 is an example of, or includes aspects of, the image processing model 1720 of FIG. 17. In some embodiments, computing device 2500 includes one or more processors 2505 that can execute instructions stored in memory subsystem 2510 to perform media generation.

According to some aspects, computing device 2500 includes one or more processors 2505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2515 operates at a boundary between communicating entities (such as computing device 2500, one or more user devices, a cloud, and one or more databases) and channel 2530 and can record and process communications. In some cases, communication interface 2515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2520 is controlled by an I/O controller to manage input and output signals for computing device 2500. In some cases, I/O interface 2520 manages peripherals not integrated into computing device 2500. In some cases, I/O interface 2520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2520 or via hardware components controlled by the I/O controller.

According to some aspects, user interface component(s) 2525 enable a user to interact with computing device 2500. In some cases, user interface component(s) 2525 include an audio device, such as an external speaker system, an external display device such as a display screen, an input device (e.g., a remote-control device interfaced with a user interface directly or through the I/O controller), or a combination thereof. In some cases, user interface component(s) 2525 include a GUI.

Performance of apparatus, systems and methods of the present disclosure have been evaluated, and results indicate embodiments of the present disclosure have obtained increased performance over existing technology. Example experiments demonstrate that the image processing apparatus and the user interface described in embodiments of the present disclosure outperforms conventional systems.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media.

For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining, via a user interface, an input image and a user input that indicates a frame for modifying the input image, wherein the frame includes a first region inside of the input image and a second region outside of the input image, and excludes a third region inside of the input image;
generating, using an image generation model, a modified image including original content from the input image in the first region and generated content in the second region, and excluding content from the input image in the third region; and
presenting the modified image for display in the user interface.

2. The method of claim 1, wherein obtaining the user input comprises:
providing a cropping tool to a user; and
receiving a drag input via the cropping tool, wherein the frame is based on the drag input.

3. The method of claim 1, further comprising:
rotating the input image, wherein the original content from the input image is oriented differently in the modified image than in the input image based on the rotation.

4. The method of claim 3, wherein rotating the input image comprises:
identifying a target orientation based on content of the input image, wherein the input image is rotated based on the target orientation.

5. The method of claim 1, further comprising:
providing a generative expand element in the user interface;
receiving a generative expand input via the generative expand element; and
initiating a generative expand mode based on the generative expand input, wherein the modified image is generated based on the generative expand mode.

6. The method of claim 1, further comprising:
receiving a text input, wherein the image generation model generates the modified image based on the text input.

7. The method of claim 1, further comprising:
providing a context bar in the user interface at a location based on the input image; and
receiving a guidance input via the context bar, wherein the generated content is based on the guidance input.

8. The method of claim 1, wherein generating the modified image comprises:
generating a multi-layer image including a first layer with the original content and a second layer with the generated content.

9. The method of claim 1, wherein:
the original content comprises a pattern and the generated content comprises a repetition of the pattern.

10. The method of claim 1, further comprising:
receiving a pattern expansion selection indicating a pattern expansion option from a plurality of pattern expansion options including a generative expansion option and an algorithmic expansion option.

11. The method of claim 1, further comprising:
generating a plurality of modified images using the image generation model based on the input image, wherein the modified image is selected from the plurality of modified images.

12. The method of claim 11, further comprising:
displaying a preview for each of the plurality of modified images, wherein the modified image is selected based on the preview.

13. A system comprising:
a memory component; and
a processing device coupled to the memory component, the processing device configured to perform operations comprising:
obtaining, using a user interface, a user input that indicates a frame for modifying an input image, wherein the frame includes a first region inside of an input image and a second region outside of the input image, and excludes a third region inside of the input image; and
generating, using an image generation model, a modified image including original content from the input image in the first region and generated content in the second region, and excluding content from the input image in the third region.

14. The system of claim 13, wherein:
the user interface comprises a cropping tool configured to receive a drag input, wherein the frame is based on the drag input.

15. The system of claim 13, wherein:
the user interface comprises a generative expand element configured to receive a generative expand input and initiate a generative expand mode based on the generative expand input, wherein the modified image is generated based on the generative expand mode.

16. The system of claim 13, wherein:
the user interface comprises a context bar at a location based on the input image and configured to receive a guidance input, wherein the generated content is based on the guidance input.

17. The system of claim 13, wherein:
the image generation model comprises a diffusion U-Net architecture.

18. A non-transitory computer readable medium storing code for image processing, the code comprising instructions that, when executed by at least one processor, cause the at least one processor to perform operations comprising:
obtaining an input image and a frame including at least a portion of the input image, wherein the input image is arranged at an oblique angle with respect to the frame;
generating, using an image generation model, a modified image including original content from the input image and generated content within a portion of the frame outside the input image; and
presenting the modified image for display in a user interface.

19. The non-transitory computer readable medium of claim 18, wherein:
the frame includes a first region inside of the input image and a second region outside of the input image, and excludes a third region inside of the input image.

20. The non-transitory computer readable medium of claim 18, wherein obtaining the input image comprises:
receiving a preliminary image;
receiving a rotation command indicating the oblique angle; and
rotating the preliminary image based on the rotation command to obtain the input image.
